(19) United States
(12) Patent Application Publication
(10) Pub. No.: US 2015/0289228 A1
(43) Pub. Date: Oct. 8, 2015

(54) ENHANCED SINGLE BURST PAGE DECODING IN A MOBILE COMMUNICATIONS NETWORK

(71) Applicant: QUALCOMM Incorporated, San Diego, CA (US)

(72) Inventors: Divaydeep Sikri, Farnborough (GB); Farrukh Rashid, Farnborough (GB); Mungal Singh Dhanda, Slough (GB); Mukund Agarwal, Farnborough (GB)

(21) Appl. No.: 14/461,232

(22) Filed: Aug. 15, 2014

Related U.S. Application Data
(60) Provisional application No. 61/976,762, filed on Apr. 8, 2014.

(51) Int. Cl. H04W 68/02; H04W 52/02

(52) U.S. Cl. CPC H04W 68/02; H04W 52/0238; H04W 88/06

(57) ABSTRACT

Aspects of the disclosure relate to wireless communication in connection with one or more devices, such as a mobile station (MS). A first burst of a multi-burst page is received from a paging channel. A correlation between at least a portion of the first burst and each of a plurality of predetermined bit patterns corresponding to a non-NULL page destined for the MS is determined. If the correlation is greater than a threshold, a second burst of the page is read and early decoding of the page is performed. Other aspects, embodiments, and features are also claimed and described.

### PRIORITY CLAIM

This application claims priority to and the benefit of U.S. Provisional Application No. 61/976,762, filed Apr. 8, 2014, the entire contents of which are incorporated herein by reference as if fully set forth below and for all applicable purposes.

### TECHNICAL FIELD

The technology discussed below relates generally to wireless communication systems, and more particularly, to paging channel decoding in a Global System for Mobile Communications (GSM) network Implementing aspects of the technology can enable and provide efficient of use of power resources and enhanced network connectivity.

### INTRODUCTION

Wireless communication networks are widely deployed to provide various communication services such as telephony, video, data, messaging, broadcasts, and so on. Such networks, which are usually multiple access networks, support communications for multiple users by sharing the available network resources. One example of such a network is a Global System for Mobile Communications (GSM) network, which utilizes a GSM air interface. Enhanced GPRS is an extension of GSM technology providing increased data rates beyond those available in second-generation GSM technology. EGPRS is also known in the field as Enhanced Data rates for GSM Evolution (EDGE), and IMT Single Carrier.

A GSM network utilizes a broadcast mechanism for distributing information to multiple mobile devices (also called user equipment, access terminal, mobile station (MS), mobile terminal, access node, etc.). For example, a paging procedure may be used to set up communication between mobile devices and a base station. A paging message (“page”) may include a message type, an MS identity (IMSI), a temporary MS identity (TMSI), a packet temporary MS identity (P-TMSI), a cell identifier list, and/or a channel needed, for example.

As the demand for mobile broadband access continues to increase, research and development continue to advance GSM technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication operable at a mobile station (MS). Here, the method includes receiving one or more bursts of a multi-burst page, and determining a correlation between at least a portion of the one or more bursts and a bit pattern corresponding to a non-NULL page (e.g., a known bit pattern). If the correlation is not greater than a threshold, the method further includes forgoing receiving one or more remaining bursts of the multi-burst page.

Another aspect of the disclosure provides an MS configured for wireless communication. Here, the MS includes at least one processor, a computer-readable medium communicatively coupled to the at least one processor, and a transceiver communicatively coupled to the at least one processor. Further, the at least one processor is configured to receive one or more bursts of a multi-burst page utilizing the transceiver, and to determine a correlation between at least a portion of the one or more bursts and a bit pattern corresponding to a non-NULL page. If the correlation is not greater than a threshold, the MS forgoes receiving one or more remaining bursts of the multi-burst page.

Another aspect of the disclosure provides an MS configured for wireless communication. Here, the MS includes means for receiving one or more bursts of a multi-burst page, means for determining a correlation between at least a portion of the one or more bursts and a bit pattern corresponding to a non-NULL page, and means for, if the correlation is not greater than a threshold, forgoing receiving one or more remaining bursts of the multi-burst page.

Another aspect of the disclosure provides a computer readable medium storing computer executable code. The code includes instructions for causing an MS to receive one or more bursts of a multi-burst page, to determine a correlation between at least a portion of the one or more bursts and a bit pattern corresponding to a non-NULL page, and, if the correlation is not greater than a threshold, to forgo receiving one or more remaining bursts of the multi-burst page.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram conceptually illustrating an example of a telecommunications system according to some embodiments.

FIG. 2 is a conceptual diagram illustrating an example of an access network according to some embodiments.

FIG. 3 is a conceptual diagram illustrating examples of Layer 2 paging patterns of a GSM network according to some embodiments.

FIG. 4 is a conceptual diagram illustrating example cases of GSM pages utilizing TMSI and/or IMSI and their corresponding bit patterns according to some embodiments.

FIG. 5 is a diagram for illustrating ½ rate convolutional coding and a generator polynomial according to some embodiments.

FIG. 6 is a conceptual diagram illustrating encoded page data mapped to four bursts of a paging channel according to some embodiments.

FIG. 7 is a diagram illustrating examples of possible bit locations of a TMSI in a first page burst of a valid non-NULL page for three types of TMSI patterns according to some embodiments.

FIG. 8 is a diagram illustrating examples of possible bit locations of an IMSI in a first page burst of a valid non-NULL page according to some embodiments.

FIG. 9 is a flow chart illustrating a method of detecting a non-NULL page by using information of a single burst according to some embodiments.

FIG. 10 is a flow chart illustrating a method of detecting a valid non-NULL page by using information of a single burst according to some embodiments.

FIG. 11 is a flow chart illustrating a method of detecting a valid non-NULL page by using information of a single burst according to some embodiments.

FIG. 12 is a block diagram illustrating an example of a hardware implementation for an apparatus employing a processing system according to some embodiments.

FIG. 13 is a table illustrating additional detail of parameters and thresholds that may be utilized by an algorithm according to some embodiments.

FIG. 14 is a flow chart illustrating a method of utilizing entry criteria corresponding to multiple thresholds in a multi-burst page block according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Aspects of the present disclosure are directed to enhanced page detection (EPD) that can enable efficient decoding of the information on a paging channel (PCH). In some scenarios, the PCH may be mapped to a common control channel (CCCH) in a global system for mobile (GSM) network. The PCH may include a multi-burst page block (e.g., a four-burst page block). The page block on the PCH may include page messages destined for at least one mobile station, or in some examples, other types of messages not limited to page messages. At a mobile station (MS), a decoded page may indicate that the MS is being paged, or that another MS is being paged, or that no MS is being paged. A page that indicates no MS is referred to as a NULL page.

An MS can operate in a variety of manners. For example, in some scenarios, a mobile station may experience a delayed wake-up, wherein the initial burst or bursts of a multi-burst page block may not be properly received or decoded. In other scenarios, a multi-SIM mobile station (having two or more subscriber identity modules, or SIMs, that the mobile station can utilize for simultaneous communication with two or more subscriptions to wireless networks) may be active on one subscription and idle on the second subscription. Here, the multi-SIM MS may fail to read one or more bursts of a multi-burst page block on the idle subscription if their timing overlaps with a data transfer operation on the active subscription. In either of these cases, a legacy mobile station that relies upon reliable reception and decoding of all bursts of a multi-burst page block may fail to detect an incoming message on the PCH.

By utilizing some of the aspects of the disclosure, non-NULL pages can be detected and/or decoded in a single GSM burst, or in a subset of bursts in a multi-burst page block. In this way, even in the case of a delayed wake-up or for de-sense in a multi-SIM mobile station, a page block can be successfully received. In some scenarios, the non-NULL page can include one or more known bit patterns or predetermined bit patterns.

For example, one or more aspects of the disclosure provide for an MS configured to use knowledge of the page message format to determine during one or more page bursts whether a valid non-NULL page is detected. Here, the page message format may include known paging patterns, coding of the pages, and knowledge of how information is mapped into the page bursts. Only when a valid non-NULL page is detected does the MS then read the remaining bursts to decode the page. Therefore, for a NULL page or non-NULL page that is not addressed to the MS, it can forgo reading more bursts after reading only one burst (or a subset of a plurality of bursts). For example, when the MS forgoes reading a burst, the MS may stop or turn off one or more components of its transceiver circuitry, such as partially or completely shutting down a receiver. In this way, the MS may reduce its power consumption and improve reliability at the same time.

Some aspects of the disclosure may use the knowledge of some or all possible page types that can be used by the network. That is, in one example, a known or predetermined bit pattern may correspond to bits in a page message indicating a page type. Page types are defined in the 3rd Generation Partnership Project (3GPP) specifications in conjunction with knowledge of the device's IMSI (International Mobile Subscriber Identity) and/or TMSI (Temporary Mobile Subscriber Identity). By combining this knowledge with a convolutional encoding, interleaving and burst mapping structure, it is possible to identify the location and bit pattern corresponding to the IMSI or TMSI for all possible page types.

Although a single burst may not capture complete information of a non-NULL page, the information from a single burst can be used to reject a PCH block not intended for the MS. For example, by using certain reliability parameters such as a burst signal-to-noise ratio (SNR) and correlation strength. On the other hand, due to the fact that the code set is not exhaustive for reading information only from the single burst, high correlation (or a correlation in an amount greater than a threshold) does not guarantee that the page is for the MS. However, aspects of the disclosure can help convert a significant proportion of early decodes into single burst decodes while waking up the MS to read the second page burst only for those TMSI/IMSI combinations that might be close in Hamming distance to the device's assigned TMSI and/or IMSI. That is, in one example, a known or predetermined bit pattern may correspond to bits in a page message indicating a TMSI, IMSI, or P-TMSI. Those TMSI/IMSI combinations that do not demonstrate a sufficiently high correlation may cause the MS to go to sleep or continue sleeping. A threshold that is used to determine whether the correlation is sufficiently high may be based on a number of symbols that are used. Moreover, the number of symbols that are taken into consideration may correspond to a portion of a single burst. The portion of the single burst may be less than an entirety of the burst.

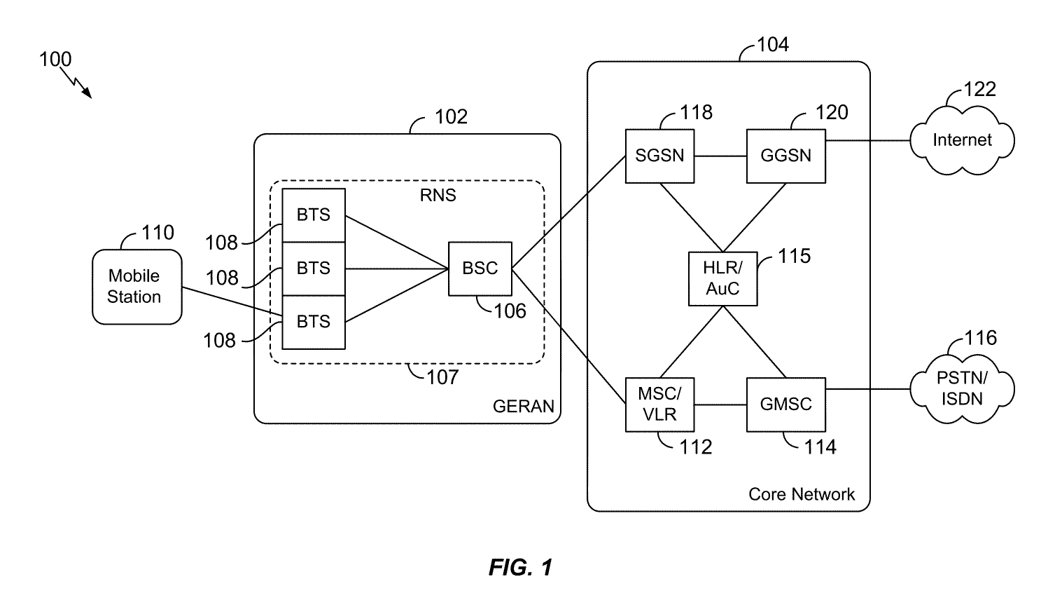

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a GSM system 100. A GSM network includes three interacting domains: a core network 104 (e.g., a GSM/GPRS core network), a radio access network (RAN) (e.g., the GSM/EDGE Radio Access Network (GERAN) 102), and mobile station (MS) 110. In this example, the illustrated GERAN 102 may employ a GSM air interface for enabling various wireless services including telephony, video, data, messaging, broadcasts, and/or other services. The GERAN 102 may include a plurality of Radio Network Subsystems (RNSs) such as an RNS 107, each controlled by a respective Base Station Controller (BSC) such as a BSC 106. Here, the GERAN 102 may include any number of BSCs 106 and RNSs 107 in addition to the illustrated BSCs 106 and RNSs 107. The BSC 106 is an apparatus responsible for, among other things, assigning, reconfiguring, and releasing radio resources within the RNS 107.

The geographic region covered by the RNS 107 may be divided into a number of cells, with a radio transceiver apparatus serving each cell. A radio transceiver apparatus is commonly referred to as a base transceiver station (BTS) in GSM applications, but may also be referred to by those skilled in the art as a base station (BS), a Node B, a radio base station, a radio transceiver, a transceiver function, a basic service set (BSS), an extended service set (ESS), an access point (AP), or some other suitable terminology. For clarity, three BTSs 108 are shown in the illustrated RNS 107; however, the RNSs 107 may include any number of wireless BTSs 108. The BTSs 108 provide wireless access points to a GSM/GPRS core network 104 for any number of mobile stations. Examples of a mobile station include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, an entertainment device, a vehicle component, a wearable device (e.g., a smart watch, a health or fitness tracker, etc.) an appliance, a sensor, a vending machine, or many other similar functioning devices. The mobile station is commonly referred to as user equipment (UE) in UMTS applications, but may also be referred to by those skilled in the art as a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The GSM “Um” air interface generally utilizes GMSK modulation (although later enhancements such as EGPRS, described below, may utilize other modulation such as 8PSK), combining frequency hopping transmissions with time division multiple access (TDMA), which divides a frame into 8 time slots. Further, frequency division duplexing (FDD) divides uplink and downlink transmissions using a different carrier frequency for the uplink than that used for the downlink. Those skilled in the art will recognize that although various examples described herein may refer to GSM Um air interface, the underlying principles are equally applicable to any other suitable air interfaces.

In some aspects of the disclosure, the GSM system 100 may be further configured for enhanced GPRS (EGPRS). EGPRS is an extension of GSM technology providing increased data rates beyond those available in 2G GSM technology. EGPRS is also known in the field as Enhanced Data rates for GSM Evolution (EDGE), and IMT Single Carrier. Specific examples are provided below with reference to the GSM system. However, the concepts disclosed in various aspects of the disclosure can be applied to any time-division-based system, such as but not limited to a UMTS system using a TDD air interface, or an e-UTRA system using a TD-LTE air interface.

For illustrative purposes, one MS 110 is shown in communication with one BTS 108 in FIG. 1. The downlink (DL), also called the forward link, refers to the communication link from a BTS 108 to an MS 110, and the uplink (UL), also called the reverse link, refers to the communication link from the MS 110 to the BTS 108.

The core network 104 can interface with one or more access networks, such as the GERAN 102. As shown, the core network 104 is a GSM core network. However, as those skilled in the art will recognize, the various concepts presented throughout this disclosure may be implemented in a RAN, or other suitable access network, to provide an MS with access to types of core networks other than GSM networks.

The illustrated GSM core network 104 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 104 supports circuit-switched services with an MSC 112 and a GMSC 114. In some applications, the GMSC 114 may be referred to as a media gateway (MGW). One or more BSCs, such as the BSC 106, may be connected to the MSC 112. The MSC 112 is an apparatus that controls call setup, call routing, and MS mobility functions. The MSC 112 also includes a visitor location register (VLR) that contains subscriber-related information for the duration that an MS is in the coverage area of the MSC 112. The GMSC 114 provides a gateway through the MSC 112 for the MS to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular MS, the GMSC 114 queries the HLR 115 to determine the location of the MS and forwards the call to the particular MSC serving that location.

The illustrated core network 104 also supports packet-switched data services with a serving GPRS support node (SGSN) 118 and a gateway GPRS support node (GGSN) 120. General Packet Radio Service (GPRS) is designed to provide packet-data services at speeds higher than those available with standard circuit-switched data services. The GGSN 120 provides a connection for the GERAN 102 to a packet-based network 122. The packet-based network 122 may be the Internet, a private data network, or some other suitable packet-based networks. The primary function of the GGSN 120 is to provide the MS 110 with packet-based network connectivity. Data packets may be transferred between the GGSN 120 and the MS 110 through the SGSN 118, which performs primarily the same functions in the packet-based domain as the MSC 112 performs in the circuit-switched domain.

In the GSM network, as briefly described above, the carriers are divided in time using a TDMA scheme, which enables different users of a single radio frequency channel to be allocated different time slots. Each time slot is allocated to a particular MS, and a GSM burst (or burst) is the transmission that is made in a time slot. An MS typically receives Paging Channel (PCH) information transmitted in a series of four bursts in corresponding time-slots of consecutive TDMA frames. The PCH is a control channel used for paging an MS when there is an incoming call addressed to the MS. A base station may use a PCH to call an individual MS within its current cell. In general, at least two bursts are needed to decode a page using a known early decoding algorithm. That is, for an early decoding algorithm, a mobile station receives two or more bursts (usually the first two bursts) of a multi-burst paging message and processes and decodes those bursts (e.g., utilizing a suitable decoding algorithm such as, but not limited to a Viterbi decoding algorithm) to obtain the page message. The obtained message may then be checked based on a suitable integrity check such as a cyclic redundancy check (CRC). Broadly, early decoding may refer to any decoding using two or more bursts of a multi-burst message prior to or without requiring reception of all of the bursts of the multi-burst message.

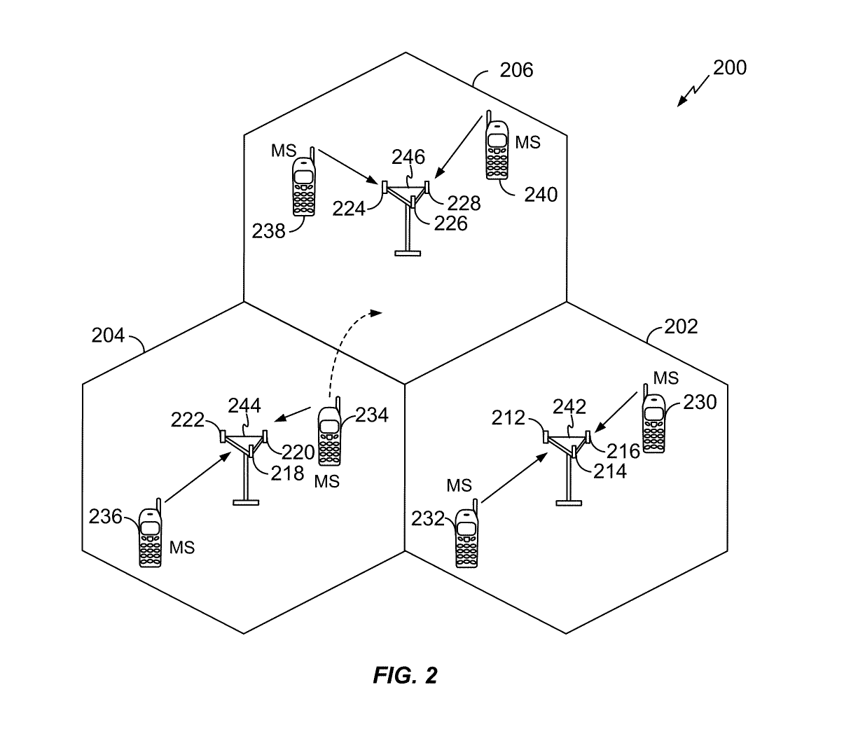

The GERAN 102 is one example of a RAN that may be utilized in accordance with the present disclosure. Referring to FIG. 2, by way of example and without limitation, a schematic illustration of a RAN 200 in a GERAN architecture is illustrated. The system includes multiple cellular regions (cells), including cells 202, 204, and 206, each of which may include one or more sectors. Cells may be defined geographically, e.g., by coverage area. In a cell that is divided into sectors, the multiple sectors within a cell can be formed by groups of antennas with each antenna responsible for communication with mobile stations in a portion of the cell. For example, in cell 202, antenna groups 212, 214, and 216 may each correspond to a different sector. In cell 204, antenna groups 218, 220, and 222 may each correspond to a different sector. In cell 206, antenna groups 224, 226, and 228 may each correspond to a different sector.

The cells 202, 204, and 206 may include several mobile stations that may be in communication with one or more sectors of each cell 202, 204, or 206. For example, MS 230 and MS 232 may be in communication with a BTS 242, MS 234 and MS 236 may be in communication with a BTS 244, and MS 238 and MS 240 may be in communication with a BTS 246. Here, each BTS 242, 244, and 246 may be configured to provide an access point to a core network 104 (see FIG. 1) for all the MSs 230,232, 234,236,238, and 240 in the respective cells 202,204, and 206.

During a call with a source cell, or at any other time, the MS 236 may monitor various parameters of the source cell as well as various parameters of neighboring cells. Further, depending on the quality of these parameters, the MS 236 may maintain communication with one or more of the neighboring cells. During this time, the MS 236 may maintain an Active Set, that is, a list of cells to which the MS 236 is simultaneously connected.

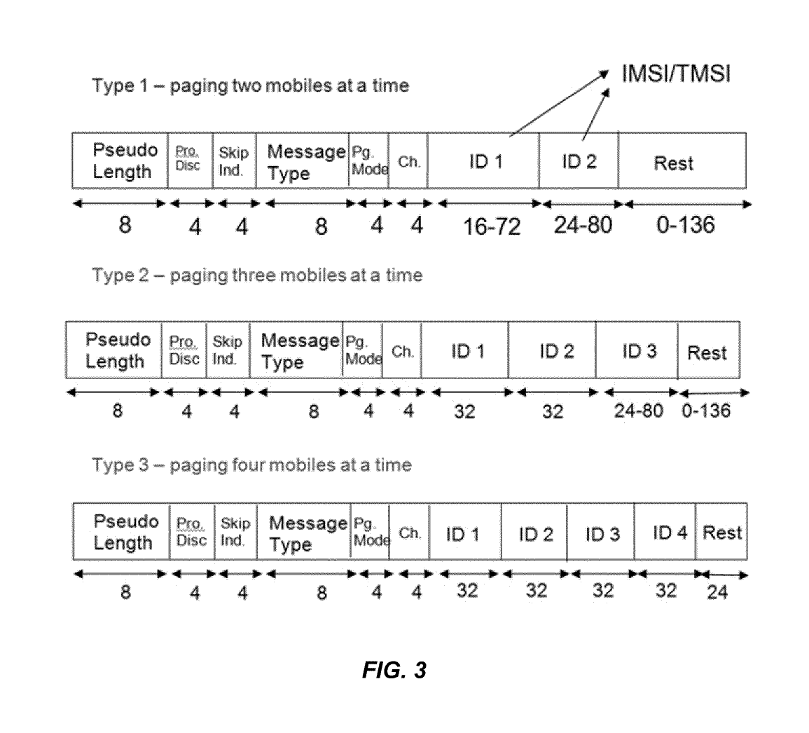

FIG. 3 is a conceptual diagram illustrating examples of Layer 2 page types in a GSM network. There are three page types used in GSM. Page Type 1 can be used to page up to two mobile devices with IMSI or TMSI in fields ID 1 and ID 2. Page Type 2 can be used to page up to three mobile devices, in which the three devices are identified with TMSI or IMSI in fields ID 1, ID 2, and ID 3. Page Type 3 can be used to page up to four mobile devices, in which all devices are identified with TMSI in fields ID 1, ID 2, ID 3, and ID 4. The paging patterns of FIG. 3 are not exhaustive, and concepts of the present disclosure may be applied to other paging patterns.

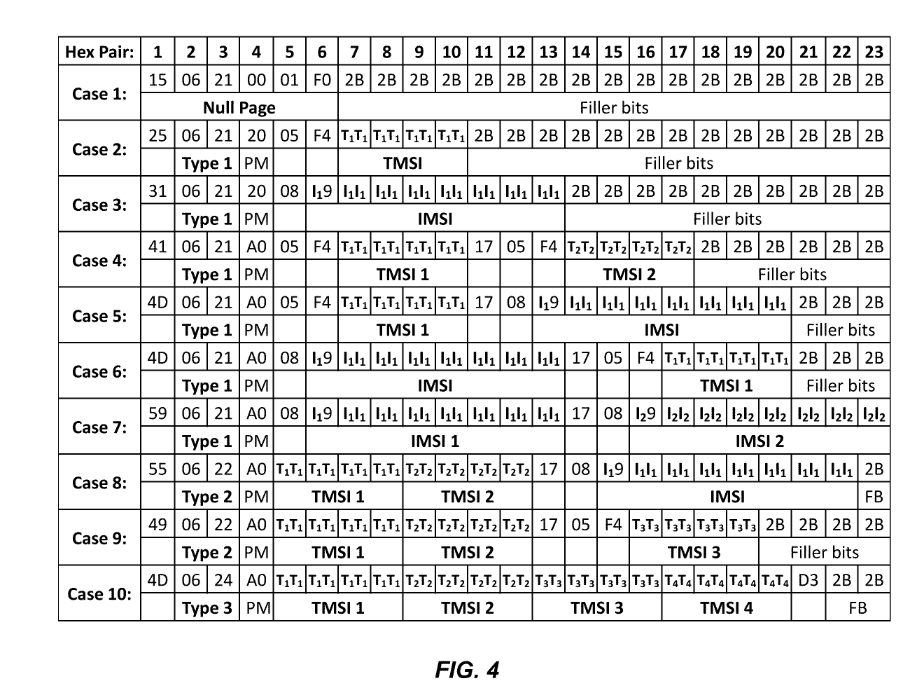

FIG. 4 is a conceptual diagram illustrating example cases of GSM pages utilizing TMSI and/or IMSI and their corresponding bit patterns. Case 1 represents a null page that contains no TMSI and IMSI of any MS. Cases 2 through 7 are Type 1 pages, as indicated by the octets 0621 appearing in Hex Pairs 2 and 3. In case 2, one MS may be paged with its TMSI, carried on Hex Pairs 7-10 as indicated by the octets labeled T₁. In case 3, one MS may be paged with its IMSI, carried on Hex Pairs 6-13 as indicated by the octets labeled I₁. In case 4, two MSs may be paged with TMSI 1 (carried on Hex Pairs 7-10 as indicated by octets labeled T₁) and TMSI 2 (carried on Hex Pairs 14-17 as indicated by octets labeled T₂), respectively. In case 5, two MSs may be paged with their TMSI (carried on Hex Pairs 7-10 as indicated by octets labeled T₁) and IMSI (carried on Hex Pairs 13-20 as indicated by octets labeled I₁), respectively. In case 6, two MSs may be paged with their IMSI (carried on Hex Pairs 6-13 as indicated by octets labeled I₁) and TMSI (carried on Hex Pairs 17-20 as indicated by octets labeled T₁), respectively. In case 7, two MSs may be paged with IMSI 1 (carried on Hex Pairs 6-13 as indicated by octets labeled I₁) and IMSI 2 (carried on Hex Pairs 16-23 as indicated by octets labeled I₂), respectively.

Cases 8 and 9 are Type 2 pages, as indicated by the octets 0622 appearing in Hex Pairs 2 and 3. In case 8, three MSs may be paged with TSMI 1 (carried on Hex Pairs 5-8 as indicated by octets labeled T₁), TSMI 2 (carried on Hex Pairs 9-12 as indicated by octets labeled T₂), and IMSI (carried on Hex Pairs 15-22 as indicated by octets labeled I₁), respectively. In case 9, three MSs may be paged with TMSI 1 (carried on Hex Pairs 5-8 as indicated by octets labeled T₁), TMSI 2 (carried on Hex Pairs 9-12 as indicated by octets labeled T₂), and TMSI 3 (carried on Hex Pairs 16-19 as indicated by octets labeled T₃), respectively.

Case 10 is a Type 3 page, as indicated by the octets 0624 appearing in Hex Pairs 2 and 3. In case 10, four MSs may be paged with TMSI 1 (carried on Hex Pairs 5-8 as indicated by octets labeled T₁), TMSI 2 (carried on Hex Pairs 9-12 as indicated by octets labeled T₂), TMSI 3 (carried on Hex Pairs 13-16 as indicated by octets labeled T₃), and TMSI 4 (carried on Hex Pairs 17-20 as indicated by octets labeled T₄), respectively.

The cases shown in FIG. 4 are not exhaustive, and the concepts and techniques of the present disclosure may also be applied to other cases not shown in FIG. 4. Moreover, in some examples within the scope of the disclosure, a correlation may be performed against all possible cases, as it may not be known a priori or beforehand which case a particular page block utilizes. To the extent that information is obtained regarding a subset of cases used in a given system environment or application, the correlation may be performed with respect to that subset.

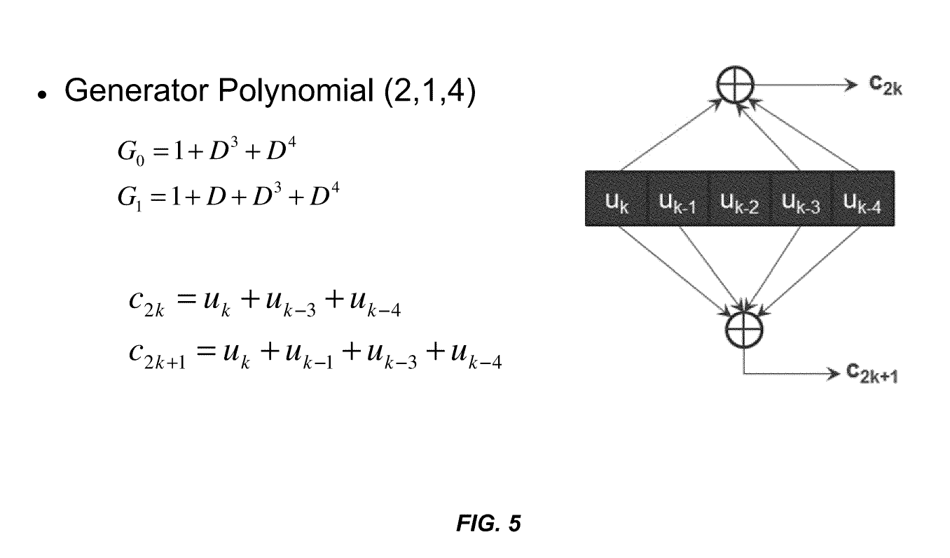

In GSM, a page consists of 184 information bits encoded and interleaved into 456 bits. An interleaver in a base station's transmitter interleaves 456 bits over four bursts. All GSM/GPRS channels with the exception of half-rate speech (TCH-HS) and adaptive multi-rate (AMR) are encoded with the ½ rate convolutional code and a generator polynomial (e.g., see FIG. 5). For example, these channels include full-rate speech (TCH-FS), enhanced full-rate (EFR), broadcast control channel (BCCH), PCH, standalone dedicated control channel (SDCCH), slow associated control channel (SACCH), fast associated control channel (FACCH), and coding schemes (CS-1 to CS-3). Following the encoding that is performed, each bit effectively is mapped to two bits.

Referring to FIG. 5, which illustrates one example of a convolutional encoder that may be utilized within the scope of the present disclosure, encoded bits cₖ are interleaved and mapped over 4 bursts for PCH/BCCH channels as per below:
i(B, j)=c(n, k) for k=0, 1 . . . , 455
   n=0, 1 . . . , N, N+1 . . .
B=B₀+4n+(k mod 4)
j=2((49k) mod 57)+((k mod 8) div 4

As illustrated in FIG. 5, G₀ and G₁ represent polynomials that are the mathematical representation of the illustrated shift register with two branches. Here, a first branch output of the shift register G₀ is represented by the exclusive OR (XOR) of the 0^{th}, 3^{th}, and 4^{th} location of the shift register, or in other representation, G₀=1+D³+D⁴. Similarly, a second branch output of the shift register G₁ is represented by the XOR of the 0^{th}, 1^{st}, 3^{th}, and 4^{th} location of the shift register, or in other representation, G₁=1+D+D³+D⁴. An equivalent way to represent the shift register is with the equations in the figure for the coded bits c₂ₖ and c₂ₖ₊₁ as a function of the uncoded bits uₖ, uₖ₋₁, uₖ₋₂, uₖ₋₃, and uₖ₋₄. Additional information on channel coding may be found in 3GPP TS 45.003.

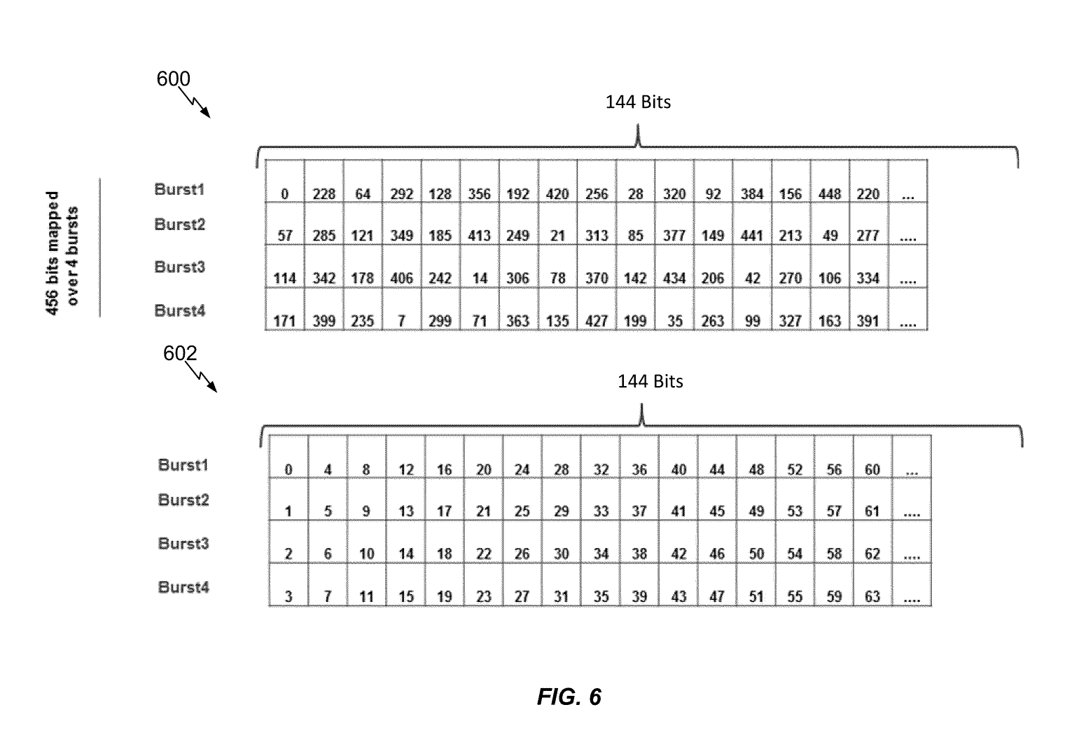

FIG. 6 is a conceptual diagram illustrating encoded page data mapped to four bursts of a PCH channel. The upper table 600 shows the actual interleaved mapping of the encoded page data. For example, burst 1 includes bits 0, 228, 64 . . . , and so on; burst 2 includes bits 57, 285, 123 . . . , and so on; burst 3 includes bits 114, 342, 178 . . . , and so on; and burst 4 includes bits 171, 399, 235 . . . , and so on. The lower table 602 shows the bits rearranged (sorted) in each of the bursts to explain how the encoded page data is distributed among the four bursts.

One or more aspects of the present disclosure enable single burst detection of the absence of a non-NULL page destined for the MS by using the coding knowledge of the coding polynomial and the consequent burst mapping as described above. That is, an MS can use knowledge of the known paging type/patterns, coding of the pages, and knowledge of how information of a page is mapped into the page bursts, to determine during a single page burst whether a valid non-NULL page is detected. Only if a valid non-NULL page is detected, does the MS then read other bursts of a multi-burst page block, and run an early decoding algorithm on that burst. For example, a P-TMSI has 4 octets (32 bits). After ½ rate encoding, 64 encoded bits will be generated. However, to ensure that the pattern is not dependent on any other data, the generator polynomial shift register uₖ to uₖ₋₄ of FIG. 5 needs to be in a state that has all bits from the P-TMSI. Because the polynomial is 4th order, it has a memory that stores 4 samples. To limit the patterns to the P-TMSI only, only 28 bits of the output will be used. These 28 bits are encoded to generate 56 bits, which will be mapped to 4 bursts, with each burst having 14 bits. For all three page types (e.g., Type 1, 2, and 3 described above in relation to FIGS. 3 and 4), the possible locations of the 14 bits within a single burst are known. Therefore, correlation may be performed between a suitable threshold and any 14 bits extracted from each of the potential locations of the burst.

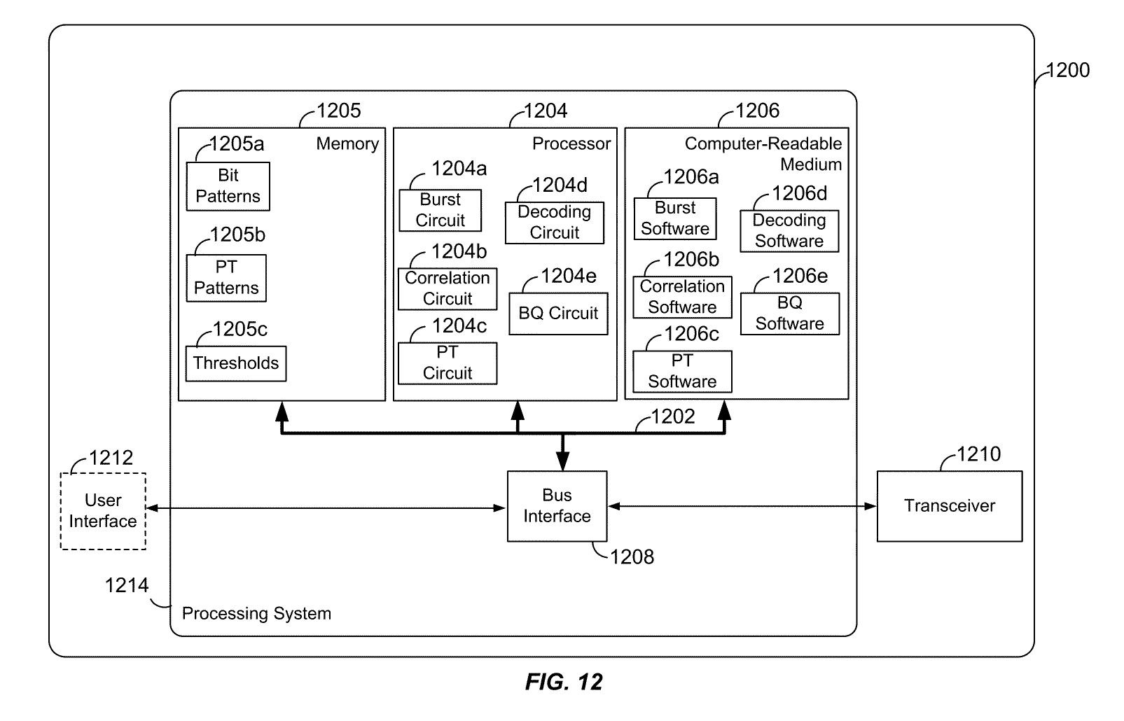

To aid the reader in understanding aspects discussed above and later in this disclosure, the reader's attention is directed to FIG. 12. This figure illustrates a block diagram illustrating an example of a hardware implementation for an apparatus 1200. The apparatus 1200, or a portion thereof, may be used to perform wireless communication following concepts discussed above and later down below.

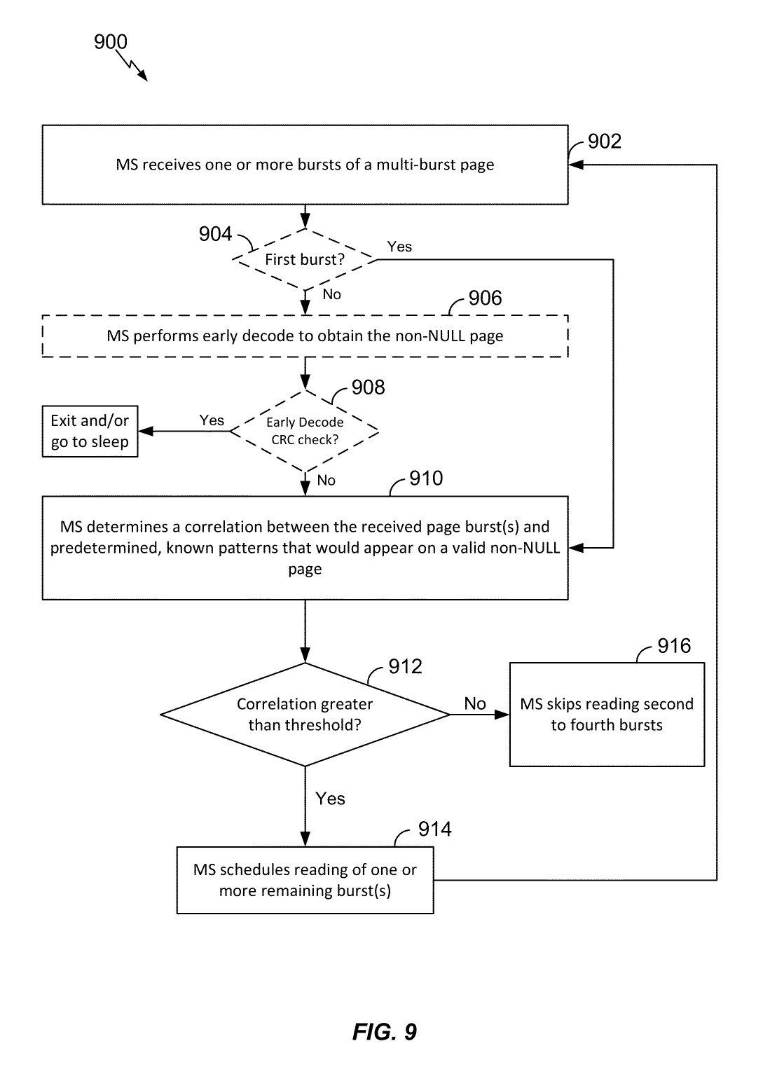

The apparatus 1200 may employ a processing system 1214. In accordance with various aspects of the disclosure, an element, or any portion of an element, or any combination of elements may be implemented with a processing system 1214 that includes one or more processors 1204. For example, the apparatus 1200 may be an MS as illustrated in any one or more of FIGS. 1 and/or 2. In another example, the apparatus 1200 may be a BTS/BSC as illustrated in FIG. 1. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 1204, as utilized in an apparatus 1200, may be used to implement any one or more of the processes or methods described and illustrated in FIGS. 9-11.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 links together various circuits or components including one or more processors (represented generally by the processor 1204), a memory 1205, and computer-readable media (represented generally by the computer-readable medium 1206). The bus 1202 may also link various other circuits such as timing sources, peripherals, voltage regulators, SIM cards, and power management circuits, which are well known in the art, and therefore, will not be described any further. A bus interface 1208 provides an interface between the bus 1202 and a transceiver 1210. The transceiver 1210 provides a means for communicating with various other apparatus over a transmission medium.

Depending upon the nature of the apparatus, a user interface 1212 (e.g., keypad, display, speaker, microphone, joystick, touchpad, touchscreen) may also be provided.

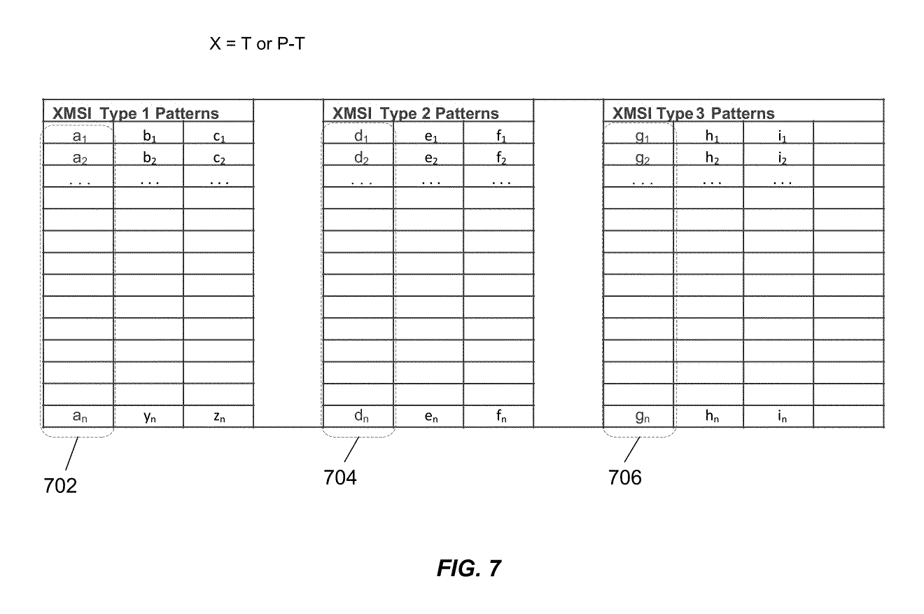

The processor 1204 is responsible for managing the bus 1202 and general processing, including the execution of software stored on the computer-readable medium 1206 and/or the memory 1205. The software, when executed by the processor 1204, causes the processing system 1214 to perform the various single burst page decoding functions described in FIGS. 7-11. The computer-readable medium 1206 may also be used for storing data that is manipulated by the processor 1204 when executing software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The computer-readable medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

The computer-readable medium 1206 may reside in the processing system 1214, external to the processing system 1214, or distributed across multiple entities including the processing system 1214.

The computer-readable medium 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The memory 1205 may be used to store data. Such data may include bit patterns 1205a. The bit patterns 1205a may include predetermined bit patterns, such as those described below in connection with FIG. 7, corresponding to a non-NULL page. The bit patterns 1205a may adhere to one or more types, such as Types 1-3 described above in connection with FIGS. 3 and 4. The bit patterns 1205a may be organized or arranged in one or more formats. For example, the bit patterns 1205a may be arranged as a table with the entries of the table being referenced by one or more addresses or indices.

In accordance with aspects of the disclosure, the transceiver 1210 is configured to receive one or more bursts, such as a first burst of a multi-burst page from a paging channel. The processor 1204 determines a correlation between at least a portion of the first burst and each of a plurality of predetermined bit patterns 1205a corresponding to a non-NULL page potentially destined for the apparatus 1200. If the correlation is greater than a threshold (e.g., as specified in thresholds 1205c as stored in the memory 1205), the processor 1204 may read a second burst of the page as received by the transceiver 1210 and perform an early decoding of the page. On the other hand, if the correlation is not greater than the threshold, the processor 1204 may forego reading a second burst of the page and may cause one or more of the components or devices of the apparatus 1200 to power-down or shut-down.

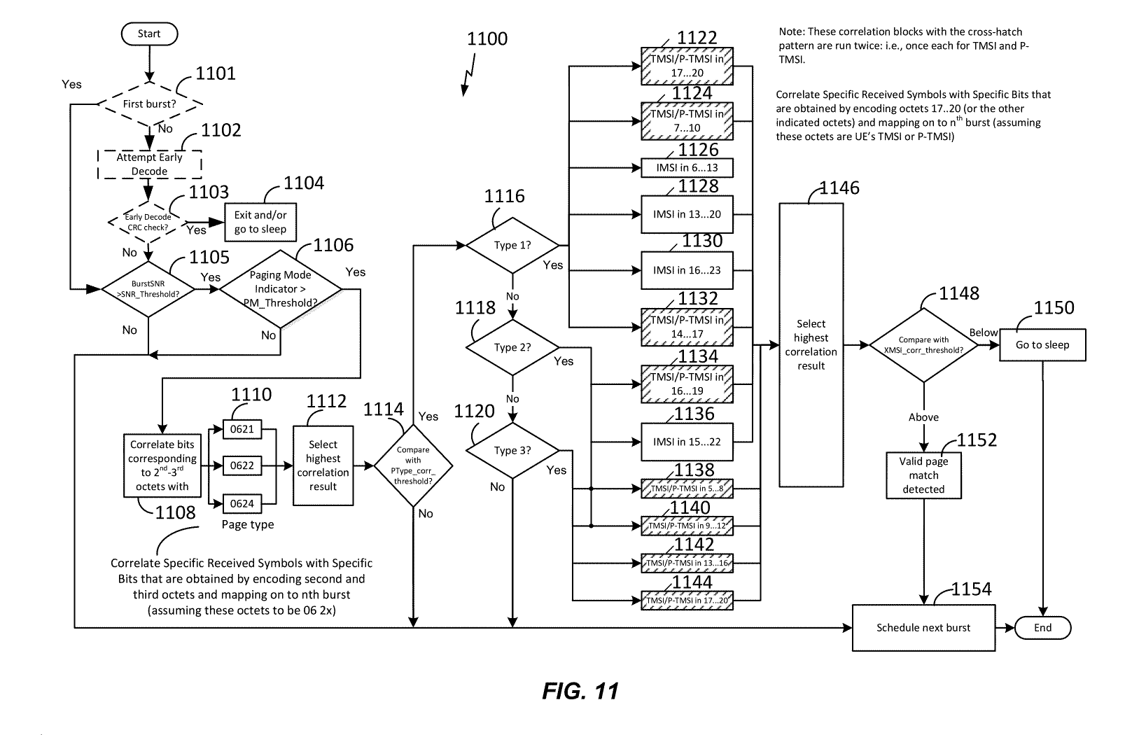

The processor 1204 may determine a page type of the multi-burst page. For example, and in reference to FIG. 11 (e.g., blocks 1102-1106) described further below, the processor 1204 may correlate second and third octets of the page with specific bits that may be calculated and stored in the memory 1205. In this respect, the processor 1204 may select a page type for the first burst based on a correlation result indicative of the PT patterns 1205b. Based on the determined or selected page type, the processor 1204 may extract bits of the portion of a single burst (e.g., blocks 1122-1144 of FIG. 11). The extracted bits may correspond to potential bit positions of at least one of encoded IMSI or TMSI bits of the first burst.

As described above, the computer-readable medium 1206 may include software. The software may be operable on a computer and/or a mobile station (MS) (e.g., a MS of either of FIGS. 1-2) for performing one or more algorithms (e.g., an algorithm associated with one or more of FIGS. 9-11 described further below).

The computer-readable medium 1206 may include burst software 1206a, correlation software 1206b, page type (PT) software 1206c, decoding software 1206d, and burst quality (BQ) software 1206e. The burst software 1206a may be used to receive one or more bursts, such as a single burst of a multi-burst page (e.g., block 902 of FIG. 9 described below).

The correlation software 1206b may be used to determine a correlation between at least a portion of the first burst and each of a plurality of predetermined bit patterns corresponding to a non-NULL page (e.g., block 910 of FIG. 9 described below). The correlation software 1206b may be used to obtain a plurality of correlations, where each correlation corresponds to one of the plurality of predetermined bit patterns.

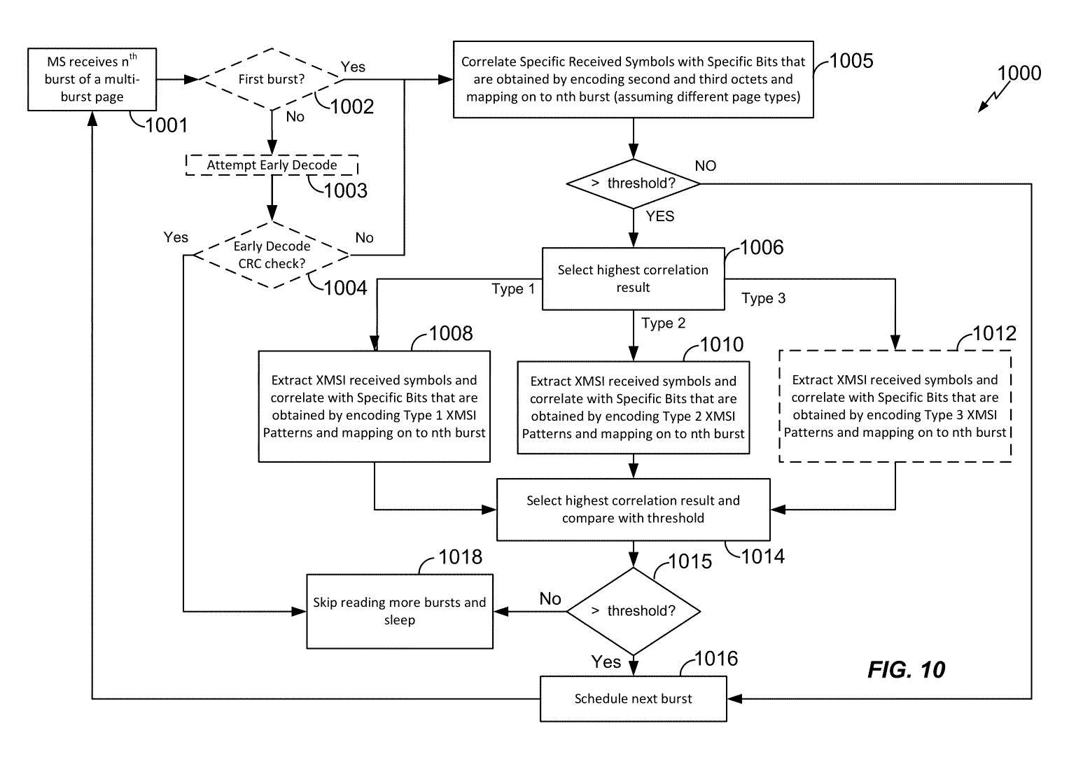

The correlation software 1206b may be operative with respect to one or more page types, such that a determination of a page type of the page may be obtained (e.g., blocks 1001-1006 of FIG. 10 described below). The determination of the page type may be facilitated via the use of the PT software 1206c. For example, the PT software 1206c may select a page type for the first burst based on a correlation result indicative of PT patterns, such as PT patterns 1205b. Based on the determined page type, the correlation software 1206b may extract bits of the portion of the first burst, where the extracted bits correspond to potential bit positions of at least one of encoded IMSI or TMSI bits of the burst (e.g., blocks 1008-1012 of FIG. 10 described below).

If the correlation, or the highest correlation among a plurality of correlations determined and selected via the correlation software 1206b, is greater than a threshold (e.g., blocks 912 and 914 of FIG. 9 described below; thresholds 1205c of memory 1205) the correlation software 1206b may cause the burst software 1206a to receive and read a second burst (or any remaining burst or bursts) of the page block.

The decoding software 1206d may perform an early decoding of one or more remaining bursts of the page (e.g., one or more bursts that were not already received at block 902) when the determined correlation is greater than the threshold (e.g., block 914 of FIG. 9 described below). On the other hand, if the correlation as determined via the correlation software 1206b is less than the threshold (e.g., blocks 912 and 916 of FIG. 9 described below) the correlation software 1206b may cause the burst software 1206a to forgo reading the second burst (or any remaining burst or bursts) of the page.

The burst quality (BQ) software 1206e may compare one or more aspects or qualities associated with a burst to one or more thresholds (e.g., as specified by thresholds 1205c). The BQ software 1206e is introduced here as a prelude to a more detailed description regarding the use of the BQ software 1206e below.

The processor 1204 may include one or more circuits. The circuits may be operable in connection with a computer and/or a mobile station (MS) (e.g., a MS of any of FIGS. 1-2) for performing one or more algorithms (e.g., an algorithm associated with one or more of FIGS. 9-11).

The processor 1204 may include a burst circuit 1204a, a correlation circuit 1204b, a page type (PT) circuit 1204c, a decoding circuit 1204d, and a burst quality (BQ) circuit 1204e. The burst circuit 1204a may receive one or more bursts, such as a single burst of a multi-burst page (e.g., block 902 of FIG. 9 described below).

The correlation circuit 1204b may determine a correlation between at least a portion of the first burst and each of a plurality of predetermined bit patterns corresponding to a non-NULL page (e.g., block 910 of FIG. 9 described below). The correlation circuit 1204b may obtain a plurality of correlations, where each correlation corresponds to one of the plurality of predetermined bit patterns.

The correlation circuit 1204b may be operative with respect to one or more page types, such that a determination of a page type of the page may be obtained (e.g., blocks 1001-1006 of FIG. 10 described below). The determination of the page type may be facilitated via the use of the PT circuit 1204c. For example, the PT circuit 1204c may select a page type for the first burst based on a correlation result indicative of PT patterns, such as PT patterns 1205b. Based on the determined page type, the correlation circuit 1204b may extract bits of the portion of the first burst, where the extracted bits correspond to potential bit positions of at least one of encoded IMSI or TMSI bits of the burst (e.g., blocks 1008-1012 of FIG. 10 described below).

If the correlation, or the highest correlation among a plurality of correlations determined and selected via the correlation circuit 1204b, is greater than a threshold (e.g., blocks 912 and 914 of FIG. 9 described below; thresholds 1205c of memory 1205) the correlation circuit 1204b may cause the burst circuit 1204a to receive and read a second burst (or any remaining burst or bursts) of the page.

The decoding circuit 1204d may perform an early decoding of the page when the determined correlation is greater than the threshold (e.g., block 914 of FIG. 9 described below). On the other hand, if the correlation as determined via the correlation circuit 1204b is less than the threshold (e.g., blocks 912 and 916 of FIG. 9 described below) the correlation circuit 1204b may cause the burst circuit 1204a to forego reading the second burst (or any remaining burst or bursts) of the page.

The burst quality (BQ) circuit 1204e may compare one or more aspects or qualities associated with a burst to one or more thresholds (e.g., as specified by thresholds 1205c). The BQ circuit 1204e is introduced here as a prelude to a more detailed description regarding the use of the BQ circuit 1204e below.

Referring now to FIG. 7, a diagram is shown illustrating possible symbol locations of an encoded XMSI (where X may represent T, as in the case of a TMSI, or P-T, as in the case of a P-TMSI) in a page burst of a valid non-NULL page for three types of XMSI patterns, such as the three types shown in FIG. 3. These patterns can be predetermined each time the MS has a new XMSI assigned by the network. The patterns can then be correctly extracted for each burst and correlated at specific locations for all possible page types. For page Type 1, three examples of an n-symbol XMSI bit pattern (or referred to as a “single burst pattern”) are shown in FIG. 7. Here, for page Type 1, a first pattern is represented with the symbols a₁, a₂, . . . aₙ; a second pattern is represented with the symbols b₁, b₂, . . . bₙ; and a third pattern is represented with the symbols c₁, c₂, . . . cₙ. Similar nomenclature is used in the illustration for page Type 2 and page Type 3. In various examples, the value of n may take any suitable positive integer value representing the number of symbols over which the correlation is computed. As one nonlimiting example corresponding to some cases of TMSI and P-TMSI, n=14.

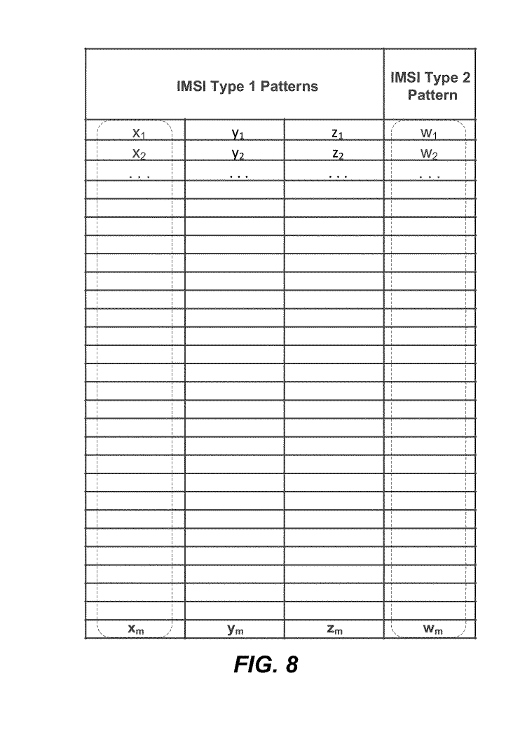

FIG. 8 is a similar diagram to FIG. 7, illustrating possible symbol locations of an encoded IMSI in a page burst of a valid non-NULL page for two types of IMSI patterns. In various examples, as in FIG. 7, the value of m may take any suitable positive integer value representing the number of symbols over which the correlation is computed. It should be appreciated that in both FIGS. 7 and 8, any suitable symbol pattern may fill the different page Types in accordance with various aspects of the disclosure. In some aspects of the disclosure, not all of the patterns necessarily need be unique. For example, one or more of the Type 2 patterns may be the same as a Type 3 pattern. As illustrated, each column accordingly represents an n-symbol pattern that the MS may seek to extract from a burst in accordance with some aspects of the disclosure.

FIG. 9 is a flow chart illustrating a method 900 of detecting a valid non-NULL page by using information of one or more bursts in accordance with an aspect of the disclosure. The method 900 may be performed by any suitable apparatus, including but not limited to the MS described above in connection with FIGS. 1 and 2; the apparatus 1200 described above and illustrated in FIG. 12; or any other suitable means for carrying out the functions described herein.

At block 902, the transceiver 1210, the burst circuit 1204a and/or the burst software 1206a at the MS 1200 may receive one or more bursts of a multi-burst page from a PCH. For example, the one or more bursts may be any combination of any one, two, or three of Burst 1, Burst 2, Burst 3, and/or Burst 4 of FIG. 6.

At block 904, the MS may optionally determine whether the received burst or bursts is (or includes) the first or initial burst of a multi-burst page block. If the received burst is not the first or initial burst, then the process may proceed to optional block 906, wherein the MS may perform an early decoding operation to obtain the non-NULL page. That is, as indicated above, an early decoding operation may be capable of decoding the multi-burst page by utilizing two or more bursts. Here, upon early decoding, an integrity check (e.g., a CRC check) may be performed to verify the early decoding operation. At block 908, if the CRC passes, then the process may exit and the UE may go to the sleep state, as further reception of bursts may not be necessary. However, if the CRC fails, then the process may proceed to block 910.

Blocks 904, 906, and 908 are indicated as being optional here. This is because a power consumption penalty may result from performing the early decode operation described in those blocks. On the other hand, a performance degradation penalty may result from omitting the early decode operation described in those blocks. An early decoding algorithm can generally consume power and processing time/resources, and it can accordingly be advantageous in some circumstances to skip the early decoding attempt. In some scenarios, there may be a trade-off between performance of the MS and power consumption—increased power consumption corresponding to the early decode attempt may result in slightly improved performance. A minor reduction in performance resulting from skipping the early decode attempt and implementing the enhanced page detection algorithm described herein and looking only for correlation between received page bursts and predetermined known patterns, however, can result in reasonable power savings.

Therefore, in some aspects of the disclosure, an MS may determine to perform an early decode operation to decode the page block, based on the power consumption corresponding to the early decode operation and/or based on the slight performance degradation resulting from omitting the early decode operation. For example, if the power consumption corresponding to the early decode operation is greater than a given threshold, then the MS may determine not to perform the early decode operation. Similarly, if a performance degradation resulting from omitting the early decode operation is more than a given threshold, then the MS may determine to perform the early decode operation. Of course, a combination of the above, or any other suitable algorithm based on the power/performance trade-off may be utilized within the scope of the present disclosure.

Returning to block 904, in the case that the received burst is the first or initial burst, then the process may proceed to block 910. At block 910, one or more of the processor 1204, the correlation circuit 1204b, the PT circuit 1204c, the correlation software 1206b, or the PT software 1206c may determine a correlation between certain bits of the one or more received page bursts, and predetermined, known bit patterns (e.g., as specified by bit patterns 1205a) that would appear on a valid non-NULL page destined for the MS. In this way, the MS may determine whether a valid non-NULL page is present on the one or more page burst(s). For example, known patterns may be patterns of the encoded IMSI and/or TMSI/P-TMSI associated with the MS contained in certain known bit positions of a burst, potentially based on one or more page types reflected in PT patterns 1205b (e.g., corresponding to an XMSI of the receiving MS). In accordance with aspects of the disclosure, bit positions of the received burst may correspond to at least a portion of the burst. The portion may be less than the entirety of the burst. In an example wherein more than one burst (e.g., two or three bursts out of a four-burst page) are received, at block 910 a correlation may be performed for each received burst and a predetermined bit pattern, and the respective correlations may be suitably combined, e.g., by adding the correlation results. In another example, the plural bursts may be concatenated together, and a single correlation may be performed between the concatenated bursts and a corresponding concatenated known burst pattern. Block 910 may be performed using one or more of the processor 1204, the correlation circuit 1204b, the PT circuit 1204c, the correlation software 1206b, or the PT software 1206c.

If, in block 912, the determined correlation is greater than a certain threshold amount (e.g., as specified by thresholds 1205c), the process may continue to block 914; otherwise, the process continues to block 916. Block 912 may be performed using the processor 1204, the correlation circuit 1204b, and/or the correlation software 1206b.

At block 914, the MS determines that a valid non-NULL page is detected.

Therefore, the MS reads a second burst and performs an early decode to obtain the non-NULL page. Here, the second burst may be any one of the bursts not read in the above block 902. Block 914 may be performed using one or more of the processor 1204, the burst circuit 1204a, the decoding circuit 1204d, the burst software 1206a, or the decoding software 1206d.

At block 916, the MS may determine that the page is not a valid non-NULL page destined for the MS and may skip reading any remaining burst or bursts of the page. As part of block 916, the MS may go to sleep. Block 916 may be performed using the processor 1204, the burst circuit 1204a and/or the burst software 1206a.

FIG. 10 is a flow chart illustrating an exemplary method 1000 of detecting a valid non-NULL page by using information of a single burst in accordance with an aspect of the disclosure. Of course, as described elsewhere in the present disclosure, the utilization of a single burst to detect a valid non-NULL page is merely one example, and in other aspects of the disclosure, the algorithm may utilize two or more bursts, e.g., any subset of bursts from a multi-burst page block. Those of ordinary skill in the art will recognize that the single-burst example illustrated in FIG. 10 and described immediately below can easily be generalized to apply to any suitable combination of one or more bursts. In various examples, the method 1000 may be performed by any suitable apparatus, including but not limited to the MS described above in connection with FIGS. 1 and 2; the apparatus 1200 described above and illustrated in FIG. 12; or any other suitable means for carrying out the functions described herein.

At block 1001, an MS receives one or more bursts (e.g., an n^{th} burst, where n is any integer) of a multi-burst page from a PCH. In one example, the n^{th} burst may be Burst 1, Burst 2, Burst 3, or Burst 4 of FIG. 6. Block 1001 may be performed using the transceiver 1210, the burst circuit 1204a, and/or the burst software 1206a.

At block 1002, the MS may determine whether the received burst or bursts is (or includes) the first or initial burst of a multi-burst page block. If the received burst is not the first or initial burst, then the process may proceed to optional block 1003, wherein the MS may attempt to perform an early decoding operation to obtain the non-NULL page. Accordingly, at block 1004, the MS may determine whether an integrity check (e.g., a CRC check) passes. As described above, the performance of the early decoding operation may be optional and implemented in a particular scenario taking into account the power/performance trade-off described above. At block 1004, if the CRC passes, then the process may proceed to block 1018 and the MS may skip reading more bursts and enter a sleep mode, as further reception of bursts may not be necessary. On the other hand, if at block 1004 the CRC fails, then the process may proceed to block 1005.

At block 1005, the MS correlates one or more specific received symbols (e.g., from within the 14 or 28 symbols of a burst described above and illustrated in FIGS. 7-8) from the n^{th} burst, with one or more specific bits corresponding to a bit pattern (e.g., a predetermined pattern). Here, the bit pattern may be obtained by encoding the second and third octets of a known page type pattern (e.g., as specified by PT patterns 1205b) and mapping the encoded octets onto the one or more received bursts. For example, the page type may be indicated by the patterns 0621, 0622, or 0624, representing a page type of Type 1, 2, or 3, respectively, as shown in FIGS. 3 and 4. These particular bits may be encoded and mapped onto the n^{th} burst, and a correlation may then be performed with those bits. Block 1004 may be performed using one or more of the processor 1204, the correlation circuit 1204b, the PT circuit 1204c, the correlation software 1206b, or the PT software 1206c.

At block 1006, the MS selects the highest correlation result indicative of the page type of the burst. If the burst is a Type 1 page (block 1006a in FIG. 10), the method may proceed to block 1008. If the burst is a Type 2 page (block 1006b in FIG. 10), the method may proceed to block 1010. If the burst is a Type 3 page (block 1006c in FIG. 10), the method may proceed to block 1012. In some examples (as illustrated), all three correlations corresponding to all three page types may each be performed individually, and the highest correlation result may be selected. Here, if none of the three are above a given threshold (i.e., a page type threshold or Ptype_corr_threshold), then the process may break out, e.g., by proceeding to block 1016 and scheduling the next burst read. In other examples, one correlation may first be performed, e.g., to correlate the n^{th} burst with a Type 1 page, and the result may be compared to a correlation threshold. If the result is above the threshold, then it is known that the n^{th} burst corresponds to a Type 1 page, and the process may proceed to block 1008. If the result is not above the threshold, then a second correlation may be performed, e.g., to correlate the n^{th} burst with a Type 2 page, and the result may be compared to a correlation threshold. If the result is above the threshold, then it is known that the n^{th} burst corresponds to a Type 2 page, and the process may proceed to block 1010. If the result is not above the threshold, then a third correlation may be performed, e.g., to correlate the n^{th} burst with a Type 3 page, and the result may be compared to a correlation threshold. If the result is above the threshold, then it is known that the n^{th} burst corresponds to a Type 3 page, and the process may proceed to block 1012. If the result is not above the threshold, then the process may break out, e.g., by proceeding to block 1016 and scheduling the next burst.

By utilizing these “break-out” conditions that proceed directly to block 1016, in an aspect of the disclosure, the network is not bound only to the use of Type 1, 2, or 3 page messages. Rather, the network is free to use the same paging block to send other types of signaling messages, such as immediate assignments for a MS that may be attempting to access the network, some other form of assignment command, or essentially any other command that the network may wish to transmit on the paging block.

Block 1006 may be performed using one or more of the processor 1204, the correlation circuit 1204b, the PT circuit 1204c, the correlation software 1206b, or the PT software 1206c.

As indicated above, blocks 1008, 1010, or 1012 may be individually executed. That is, in a particular implementation, only one of these blocks need be executed according to the correlation results described above. At block 1008, corresponding to an example where a Type 1 page is detected, the MS extracts XMSI symbols (where X represents I, for an IMSI, T, for a TMSI, or P-T, for a P-TMSI) from a number of possible bit positions, and correlates the extracted bits with specific bits that may be obtained by encoding Type 1 XMSI patterns and mapping onto the n^{th} burst. In some examples, three passes may be made herein, to correlate the received symbols with each of IMSI, TMSI, and P-TMSI patterns. Block 1008 may be performed using one or more of the processor 1204, the correlation circuit 1204b, the PT circuit 1204c, the correlation software 1206b, and the PT software 1206c.

At block 1010, corresponding to an example where a Type 2 page is detected, the MS extracts XMSI symbols from a number of possible bit positions, and correlates the extracted bits with specific bits that may be obtained by encoding Type 2 XMSI patterns and mapping onto the n^{th} burst. In some examples, three passes may be made herein, to correlate the received symbols with each of IMSI, TMSI, and P-TMSI patterns. Block 1010 may be performed using one or more of the processor 1204, the correlation circuit 1204b, the PT circuit 1204c, the correlation software 1206b, or the PT software 1206c.

At block 1012, corresponding to an example where a Type 3 page is detected, the MS extracts XMSI symbols from a number of possible bit positions, and correlates the extracted bits with specific bits that may be obtained by encoding Type 3 XMSI patterns and mapping onto the n^{th} burst. Referring once again to FIG. 4, it can be seen that a Type 3 page does not provide for identifying an MS with an IMSI. Accordingly, if the correlation result shows that the algorithm is dealing with a Type 3 page, then X I (i.e., the identifier would not correspond to an IMSI). Therefore, in some examples, two (rather than three) passes may be made herein, to correlate the received symbols with each of TMSI and P-TMSI patterns. Block 1012 may be performed using one or more of the processor 1204, the correlation circuit 1204b, the PT circuit 1204c, the correlation software 1206b, or the PT software 1206c.

At block 1014, the MS selects the highest correlation result corresponding to a detected XMSI pattern, and compares it with the threshold (e.g., as specified by thresholds 1205c) in block 1015. If the correlation is greater than the threshold, the method continues to block 1016; otherwise, the method continues to block 1018 and skips reading any more bursts and enters a sleep mode. Block 1014 may be performed using the processor 1204, the correlation circuit 1204b, and/or the correlation software 1206b.

At block 1016, the MS may move on to the next burst (e.g., the n+1^{th} burst). Block 1016 may be performed using the processor 1204.

At block 1018, the MS may skip reading any further bursts of the multi-burst page block (e.g., skipping the second to fourth bursts if the n^{th} burst is the first burst), and sleeps to save power. Block 1018 may be performed using the processor 1204, the burst circuit 1204a, and/or the burst software 1206a.

In some aspects of the disclosure, the single burst page decoding methods 900 and 1000 may be performed only when the signal quality (e.g., signal-to-interference ratio (SIR) or signal-to-noise ratio (SNR)) of the PCH is above a certain threshold. It is because when the signal quality of the PCH is undesirable, it may be difficult to determine the existence of a valid non-NULL page based on only a single burst.

FIG. 11 is a flow chart illustrating a method 1100 of detecting a valid non-NULL page by using information of a single burst in accordance with further aspects of the disclosure. While various aspects of the present disclosure may be applied to the reception of any subset of a multi-burst page block (e.g., two or three out of four bursts in a four-burst page block), those examples have many similarities to a single-burst example, so the single-burst example is primarily described and illustrated. Where deviations from the single-burst case may occur in the case of a two- or three-burst detection of a valid non-NULL page, in the description below, those deviations may be specifically pointed out. In various examples, the method 1100 may be performed by any suitable apparatus, including but not limited to the MS described above in connection with FIGS. 1 and 2; the apparatus 1200 described above and illustrated in FIG. 12; or any other suitable means for carrying out the functions described herein.

Referring to FIG. 11, an MS may receive an n^{th} burst of a multi-burst page on a PCH. The receipt of the n^{th} burst may correspond to blocks 902 and 1001 of FIGS. 9 and 10, respectively, and may be performed using the transceiver 1210, burst circuit 1204a and/or the burst software 1206a. In one example, the n^{th} burst may any one of Burst 1 through Burst 4 of FIG. 6.

Here, at block 1101, the MS may determine whether the received n^{th} burst is the first or initial burst. In some examples, e.g., when the n^{th} burst is not the first or initial burst, then at optional block 1102 the MS may attempt an early decode of the multi-burst page block, and at optional block 1103, the MS may perform an integrity check (e.g., a CRC) on the decoded block. As described above, the performance of the early decoding operation may be optional and implemented in a particular scenario taking into account the power/performance trade-off described above. If the CRC passes, then the process may proceed to block 1104, exiting the EPD algorithm, and the MS can skip reading the next burst and/or go to sleep. On the other hand, if the CRC fails, or if blocks 1102-1103 is not performed, then the process may proceed to block 1105.

Here, at block 1105 the receiving MS may measure a signal to noise ratio (SNR) of the received n^{th} burst. If, at block 1105, the MS determines that the SNR of the burst is above a certain SNR threshold (i.e., SNR_Threshold), then the process may proceed to block 1106. If the determined SNR is not above the SNR threshold, the process may break out, proceeding to block 1154, described in further detail below. The SNR threshold associated with block 1105 may be specified by the threshold block 1205c (see FIG. 12). Block 1105 may be performed using the processor 1204, the BQ circuit 1204e, and/or the BQ software 1206e.

At block 1106, the MS may perform a paging mode indicator (PMI) check.

Here, the MS may look to a paging mode indicator field (e.g., see FIG. 3). The paging mode indicator field is generally a 4-bit field. The MS may accordingly take a paging mode having a particular value, encode the particular value, and map it onto the burst, and then extract the received symbol it corresponds to.

In an aspect of the disclosure, the PMI check at block 1106 may not utilize a correlation to determine the value of the PMI. That is, the PMI check may be based on a comparison between a soft decision of the value in the PMI field itself and a page mode threshold.

In a further aspect of the disclosure, wherein two or more bursts (e.g., a subset) of a multi-burst page block are received, at block 1106 a weighted average of a modulo-sum of the PMI values (e.g., a sum of the absolute values of the symbols divided by the number of bursts) may be calculated. Here, the threshold against which the PMI value (i.e., the weighted average of the PMI values) is compared may be the same independent of the number of bursts, or in another example, may vary according to the number of bursts. Thus, the weighted average of the received and detected PMI symbols may be compared to a given threshold to determine the page mode indicator value.

Of course, this is merely one example, and in another example, the modulo-sum of the PMI values (e.g., a sum of the absolute values of the symbols) may be calculated. Here, the threshold against which the PMI value (i.e., the sum of the PMI values) is compared may be correspondingly scaled up, e.g., doubled where two bursts are received, tripled where three bursts are received, etc. That is, the sum of absolute values of the received and detected PMI symbols may be compared to a scaled threshold to determine the page mode indicator value.

In any case, whether one or a plurality of bursts are received, if a paging mode indicator check is above a certain threshold (block 1106), the method 1100 may proceed to block 1108; otherwise, the method 1100 may break out, proceeding to block 1154, described below. Here, the threshold associated with block 1106 may be specified by the threshold block 1205c (see FIG. 12). Block 1108 may be performed using the processor 1204, the BQ circuit 1204e, and/or the BQ software 1206e.

This paging mode indicator check of block 1106 determines whether or not the paging mode indicator bit(s) in the n^{th} burst indicate that the paging message contains the signaling message or an indication from the network to receive additional extended paging block(s). The bit index of the paging mode indicator bits in the n^{th} burst may be obtained by checking the bits corresponding to the 4-bit paging mode field in the original 23 paging blocks after encoding and mapping on to the 4 bursts. Among the bits mapped to the n^{th} burst, these paging mode indicator bits in the n^{th} burst, have different values for normal paging and extended paging messages.

At block 1108, the MS correlates specific received symbols from the n^{th} burst, e.g., the second and third octets, with specific bits corresponding to known page type patterns 1110 (e.g., as specified by PT patterns 1205b), for example, 0621, 0622, and 0624, corresponding to Page Types 1, 2, and 3, as shown in FIGS. 3-4. The hex pair 0621 corresponds to page Type 1, the hex pair 0622 corresponds to page Type 2, and the hex pair 0624 corresponds to page Type 3 as shown in FIGS. 3 and 4. Block 1108 may be performed using one or more of the correlation circuit 1204b, the PT circuit 1204c, the correlation software 1206b, and the PT software 1206c.

At block 1112, the MS may select the highest correlation result indicative of the page type of the burst. Here, if none of the correlation results are greater than a page type correlation threshold (PType_corr_threshold), then the process may break out and proceed to block 1154, described in further detail below. However, if at least one of the correlation results from block 1114 are above the PType_corr_threshold, then the process may proceed to block 1116. In some aspects of the disclosure, the PType correlation threshold utilized at block 1114 may be selected in accordance with which burst of a multi-burst page is being analyzed. For example one threshold may be utilized if a single, first burst is being analyzed, while a second threshold may be utilized if two or more bursts are being analyzed in combination. In another example, the PType correlation threshold may be a fixed threshold value for any number of bursts, but the value being compared to the threshold may correspond to a weighted average of a plurality of correlation values, corresponding to each burst. Block 1114 may be performed using one or more of the processor 1204, the correlation circuit 1204b, the PT circuit 1204c, the correlation software 1206b, and/or the PT software 1206c.

If the burst is a Type 1 page (e.g., the output of block 1116 is a “yes”), the MS extracts XMSI bits from a number of possible bit positions and correlates the extracted bits with known XMSI patterns (e.g., as specified by bit patterns 1205a) of a Type 1 page destined for the MS. In an aspect of the disclosure, the extracted bits may be correlated with the XMSI patterns of blocks 1122 through 1132. That is, in some examples, six branches may come out of block 1116 corresponding to a Type 1 page, indicating that six correlations may be determined in this case in some examples. For example, the pattern of block 1122 may correspond to case 2 of FIG. 4, in which the Hex Pairs 7 through 10 may be extracted for correlation with a known TMSI pattern.

If the burst is a Type 2 page (e.g., the output of block 1118 is a “yes”), the MS extracts XMSI bits from a number of possible bit positions and correlates the extracted bits with known XMSI patterns (e.g., as specified by bit patterns 1205a) of a Type 2 page destined for the MS. In an aspect of the disclosure, the extracted bits may be correlated with the XMSI patterns of blocks 1134 through 1140. That is, in some examples, four branches may come out of block 1118 corresponding to a Type 2 page, indicating that four correlations may be determined in this case in some examples. For example, the pattern of block 1134 may correspond to case 8 of FIG. 4 in which the Hex Pairs 15 through 22 may be extracted for correlation with a known IMSI pattern.

If the burst is a Type 3 page (e.g., the output of block 1106c is a “yes”), the MS extracts XMSI bits from a number of possible bit positions and correlates the extracted bits with known XMSI patterns (e.g., as specified by bit patterns 1205a) of a Type 3 page destined for the MS. In an aspect of the disclosure, the extracted bits may be correlated with the XMSI patterns of blocks 1138 through 1144. That is, in some examples, four branches may come out of block 1120 corresponding to a Type 3 page, indicating that four correlations may be determined in this case in some examples. For example, the pattern of block 1138 may correspond to case 10 of FIG. 4 in which the Hex Pairs 5 through 8 may be extracted for correlation with a known TMSI pattern.

In some examples, all three correlations may be performed, and the maximum correlation value may be determined. In other examples, individual correlations may be performed in sequence, proceeding to the next correlation check if the current correlation value is not greater than a given threshold.

Blocks 1122-1144 indicate a correlation implemented by the MS corresponding to an XMSI. That is, as with other correlations described above, the MS may encode the indicated octets (e.g., in block 1122, octets located at Hex Pairs 17-20 as illustrated in FIG. 4) and map the encoded octets onto the n^{th} burst. This is then correlated with the specific received symbols corresponding to those indicated octets.

In some aspects of the disclosure, a plurality of correlation results may be obtained. As one example, if at block 1116 the MS determines that the received message corresponds to a Type 1 page, then the process implements at least one correlation at each of six blocks 1122-1132. Further, in each of the blocks illustrated with the cross-hatch pattern, i.e., blocks 1122, 1124, 1132, 1134, 1138, 1140, 1142, and 1144, the correlation may be obtained twice: once for a TMSI and once for a P-TMSI, which might appear at the same indicated location. Similarly, if at block 1118 the MS determines that the received message corresponds to a Type 2 page, then the process may implement at least one correlation at each of four blocks 1134, 1136, 1138, and 1140; and if at block 1120 the MS determines that the received message corresponds to a Type 3 page, then the process may implement at least one correlation at each of four blocks 1138, 1140, 1142, and 1144.

In a further aspect of the disclosure, corresponding to a multi-SIM case (e.g., a dual-SIM dual active, dual-SIM dual standby, or any other suitable device with two or more SIMs), the correlation described above at blocks 1122-1144 corresponding to an XMSI may be performed a plurality of times, corresponding to each of the plurality of SIMs. That is, it may be the case that each of a plurality of SIMs has its own XMSI. Here, the MS may wish to determine whether an incoming page message is directed to any one of the plurality of SIMs. Accordingly, the MS may perform the EPD procedure described in the present disclosure, for example, as illustrated in FIG. 11, except for performing multiple iterations of an XMSI correlation as would be suitable for a device with multiple SIMs and correspondingly multiple XMSIs.

Following the execution of the correlations to find the XMSI, the process proceeds to block 1146, wherein the MS selects the highest correlation result and compares it with a corresponding XMSI correlation threshold (e.g., as specified by thresholds 1205c) in block 1148. Here, the XMSI correlation threshold may be selected in accordance with which burst of the multi-burst page is being analyzed, e.g., utilizing one threshold if a single, first burst is being analyzed, but utilizing a second threshold if two or more bursts are being analyzed in combination. In another example, the XMSI correlation threshold may be a fixed threshold value for any number of bursts, but the value being compared to the threshold may correspond to a weighted average of a plurality of correlation values, corresponding to each burst. If the correlation (or the calculated value corresponding to a plurality of correlations) is greater than the XMSI correlation threshold, a valid page match is detected (block 1152) and the process continues to block 1154; otherwise, the process continues to block 1150 where the MS may skip reading the second to fourth bursts and sleeps to save power. Block 1150 may be performed using the processor 1204, the burst circuit 1204a, and/or the burst software 1206a. Blocks 1146 and 1148 may be performed using the processor 1204, the correlation circuit 1204b, and/or the correlation software 1206b.

At block 1154, the MS schedules the reading of the next burst (or any remaining burst or bursts) because, e.g., the SNR of the n^{th} burst may not meet the threshold needed to use the information of a single n^{th} burst to detect a valid non-NULL page (block 1105), or the paging mode indicator (PMI) is less than a threshold (block 1106). Flow may proceed to block 1154 for other reasons, such as a detection of a valid page match (block 1152) described further below. Block 1154 may be performed using one or more of the processor 1204, the burst circuit 1204a, the decoding circuit 1204d, the burst software 1206a, or the decoding software 1206d.

The various thresholds described above and associated with one or more of the blocks 1104, 1106, 1112, and 1148 may be selected in accordance with one or more suitable parameters or factors, or in other examples, may be predetermined. The value utilized as the threshold may be configured or selected so as to provide a given or predetermined degree of accuracy. For example, the thresholds may be selected so as to avoid causing the MS to go to sleep (e.g., at block 1150) with a certain degree of reliability when paging messages or bursts are intended for the MS. It may in some examples be desirable to select the thresholds in such a manner that an over-decoding condition (e.g., unnecessarily decoding by the MS bursts intended for another MS) occurs with a greater likelihood than causing the MS to ignore messages or bursts that are intended to be received and processed by the MS.

In some examples, the value to utilize for a given threshold may vary in accordance with the number of bursts that are processed. That is, in some aspects of the disclosure, the method 1100 may be applied to the second, third, and/or fourth burst(s) of a multi-burst page block from a PCH. In a delayed wake-up case, the MS wakes up late, and an initial burst or the initial two or three bursts of the multi-burst page block may be missed. If the initial burst or bursts are missed, the method 1100 may be applied to one or more remaining bursts, and the non-NULL page decoding process for the initial burst or bursts remains substantially the same as that described in relation to the n^{th} burst above. In this case, the bit mapping for the remaining burst or bursts is used instead of that for the single n^{th} burst. Therefore, the tables (e.g., tables 702, 704, and 706 of FIG. 7) for the seven permutations of n (e.g., 14) bits for TMSI/P-TMSI, or for the m (e.g., 28) bits of the IMSI illustrated in FIG. 8, may change accordingly. The MS can perform a single burst decode for non-NULL pages with just any single burst alone, instead of needing all of the remaining bursts for an early decode (e.g., a 2-burst decode to get the payload data). Additionally, the MS can perform a multi-burst decode for non-NULL pages with any suitable number of bursts, including 2, 3, or 4 bursts, or more.

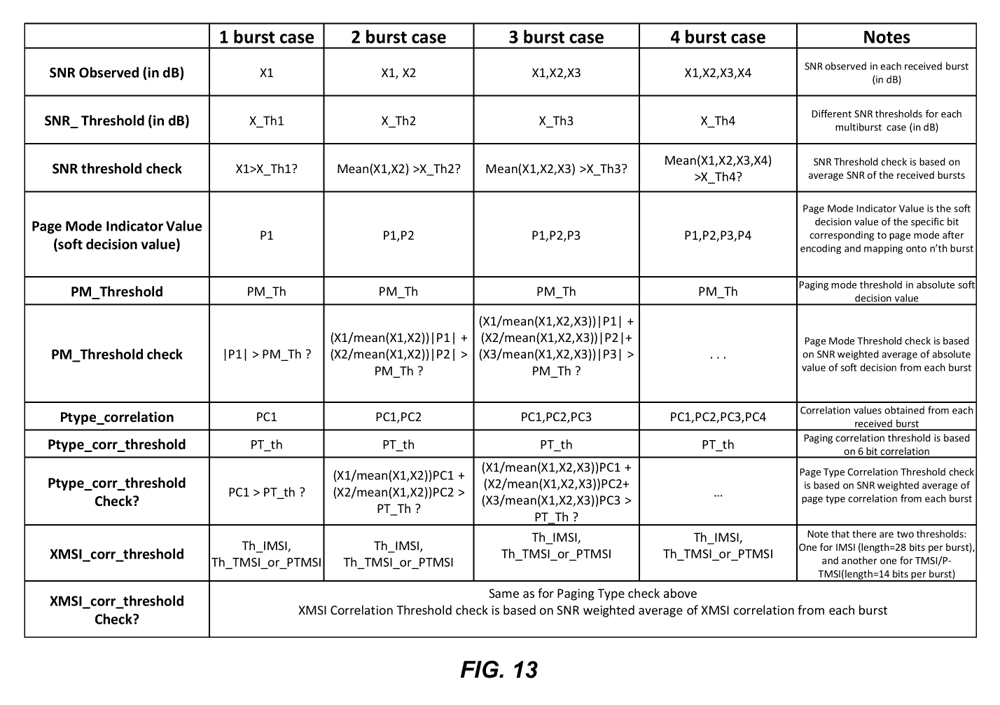

FIG. 13 shows a table that provides additional information about the various parameters and thresholds that may be utilized in some aspects of the disclosure, as described above in relation to FIG. 11. For example, the referring to block 1104, the MS may observe a signal-to-noise ratio (SNR), in dB, for each received burst, and compare this SNR to an SNR threshold. The SNR threshold may be different in cases with different numbers of observed bursts. In the case of a multi-burst observation, the threshold check at block 1104 may be made by taking the mean value of the observed SNR for each burst, and comparing that mean to the corresponding SNR threshold.

Referring now to block 1106, the page mode indicator value corresponds to a soft decision value of the specific bit or bits corresponding to the page mode, after encoding and mapping onto the n^{th} burst (or each of the bursts in a multi-burst observation). The page mode indicator (PMI) value is compared to a page mode threshold PM_Threshold, represented as PM_Th. The page mode threshold PM_Th is the absolute soft decision value. Here, as described above, the page mode threshold check may be performed not by executing a correlation, but rather by comparing the weighted average of the PMI values with a given page mode threshold.

Referring now to block 1114, as described above, a page type correlation threshold (PType_corr_threshold) may be utilized to determine whether at least one of the page type correlation results is good enough to proceed. Here, in some aspects of the disclosure, the page type correlation value may be determined from each received burst, and the page type correlation threshold may be based on the usage of a 6-bit correlation. That is, in general, a correlation threshold may depend on the size of the correlation. At block 1114, the three different paging types are all of the same size, i.e., two octets. Here, the threshold may be based on the taking of those two octets, encoding them, and mapping them onto the burst. Here, the length of the correlation ends up being 6 symbols. That is, the page type consists of two octets, or 16 bits. Four of these bits may be utilized to initialize a Viterbi encoder, leaving 12 bits remaining. These 12 bits, after half-rate encoding, result in 24 bits. These 24 bits are mapped to 4 bursts, giving 6 bits each. Thus, the correlation corresponds to 6 bits for each page type. The page type correlation threshold check may be based on an SNR weighted average of the page type correlation from each burst of the one or more bursts received.

Referring now to block 1148, as described above, an XMSI correlation threshold (XMSI_corr_threshold) may be utilized to determine whether at least one of the XMSI correlation results is good enough to proceed. Here, in some aspects of the disclosure, the XMSI correlation value may be determined from each received burst. Furthermore, the XMSI correlation value may be determined two times for a single burst, to look for a TMSI and for a P-TMSI. The XMSI correlation threshold may be based on the usage of, for example, either a n- or m-bit correlation, depending on whether the XMSI is a TMSI/P-TMSI (n bits) or an IMSI (m bits). The XMSI correlation threshold check may be based on an SNR weighted average of the XMSI correlation from each burst of the one or more bursts received.

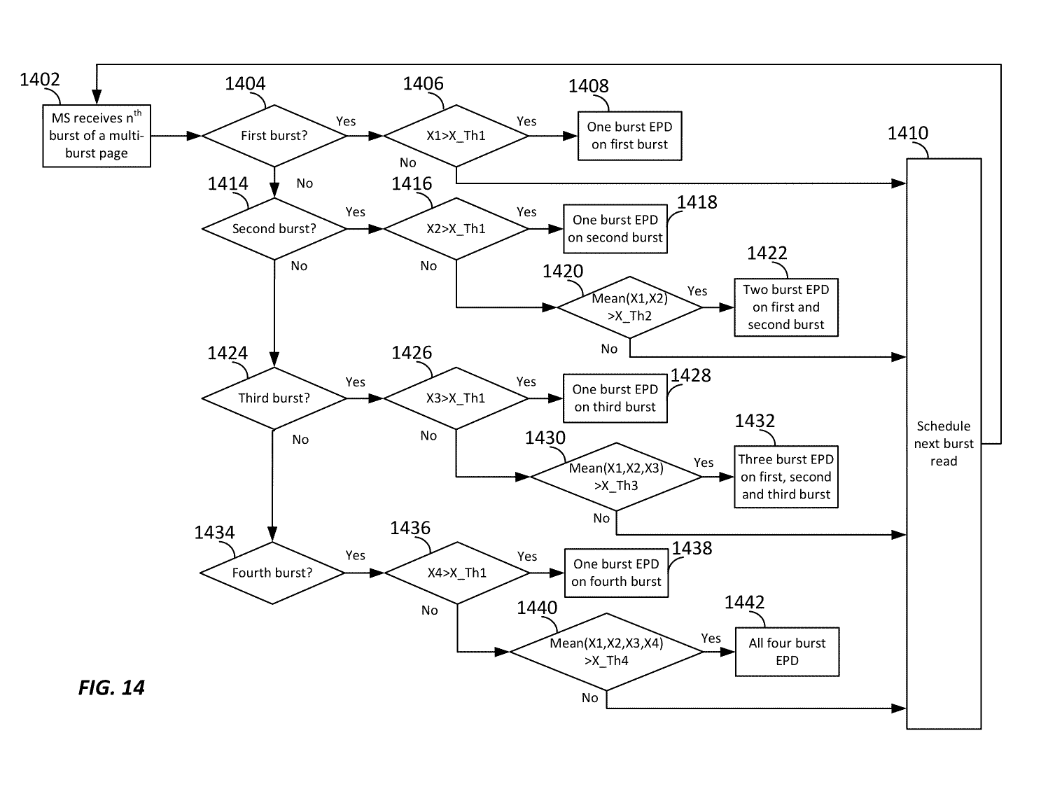

FIG. 14 is a flow chart illustrating a method 1400 of processing sequential bursts in a multi-burst page block in accordance with some aspects of the present disclosure. The process 1400 generally illustrates how an MS can utilize the various thresholds illustrated in FIG. 13, which may vary in accordance with which burst of the multi-burst page is being processed. Process 1400 may be utilized in coordination with the other processes described herein above, including process 900 (see FIG. 9), process 1000 (see FIG. 10), and process 1100 (see FIG. 11).

At block 1402, the MS may receive an n^{th} burst of a multi-burst page on a PCH.

The receipt of the n^{th} page may correspond to blocks 902 and 1001 of FIGS. 9 and 10, respectively, and may be performed using the transceiver 1210, burst circuit 1204a, and/or the burst software 1206a. In one example, the n^{th} burst may be any one of Burst 1 through Burst 4 of FIG. 6.

At block 1404, the MS may determine whether the received n^{th} burst is the first or initial burst of the multi-burst page block. If the burst is the first or initial burst, then the process may proceed to block 1406, wherein the MS may determine whether the SNR X1 observed corresponding to the burst is greater than the SNR threshold utilized for the one-burst case, i.e., X_Th1. If X1>X_Th1, then the process may proceed to block 1408, wherein an enhanced page detection (EPD) procedure as described in the present disclosure, e.g., corresponding to FIG. 9, 10, and/or 11 may be performed to determine whether the n^{th} burst corresponds to a valid non-NULL page. On the other hand, if at block 1406 it is determined that the SNR is not greater than the threshold (e.g., X1≦X_Th1), then the process may proceed to block 1410, wherein the MS may schedule the next burst read.

Returning to block 1404, if it is determined that the received n^{th} burst is not the first burst, then the MS may proceed to block 1414 to determine whether the burst is the second burst. If the burst is the second burst, then the process may proceed to block 1416, wherein the MS may determine whether the SNR X2 observed corresponding to the second burst is greater than the SNR threshold utilized for a one-burst case, i.e., X_Th1. If X2>X_Th1, then the process may proceed to block 1418, wherein an EPD procedure as described in the present disclosure, e.g., corresponding to FIG. 9, 10, and/or 11 may be performed to determine whether the n^{th} burst corresponds to a valid non-NULL page. On the other hand, if at block 1416 it is determined that the SNR is not greater than the threshold (e.g., X2≦X_Th1), then the process may proceed to block 1420, wherein the MS may determine whether a mean of the SNR X1 observed corresponding to the first burst, and the SNR X2 observed corresponding to the second burst, is greater than an SNR threshold used for a two-burst case, i.e., X_Th2. If Mean(X1, X2)>X_Th2, then the process may proceed to block 1422, wherein an EPD procedure as described in the present disclosure, e.g., corresponding to FIG. 9, 10, and/or 11 may be performed to determine whether the received bursts correspond to a valid non-NULL page. On the other hand, if at block 1420 it is determined that the mean SNR is not greater than the threshold (e.g., Mean(X1, X2)≦X_Th2), then the process may proceed to block 1410, wherein the MS may schedule the next burst read.

Returning to block 1414, if it is determined that the received n^{th} burst is not the second burst, then the MS may proceed to block 1424 to determine whether the burst is the third burst. If the burst is the third burst, then the process may proceed to block 1426, wherein the MS may determine whether the SNR X3 observed corresponding to the third burst is greater than the SNR threshold utilized for a one-burst case, i.e., X_Th1. If X3>X_Th1, then the process may proceed to block 1428, wherein an EPD procedure as described in the present disclosure, e.g., corresponding to FIG. 9, 10, and/or 11 may be performed to determine whether the n^{th} burst corresponds to a valid non-NULL page. On the other hand, if at block 1426 it is determined that the SNR is not greater than the threshold (e.g., X3≦X_Th1), then the process may proceed to block 1430, wherein the MS may determine whether a mean of the SNR X1 observed corresponding to the first burst, the SNR X2 observed corresponding to the second burst, and the SNR X3 observed corresponding to the third burst, is greater than an SNR threshold used for a three-burst case, i.e., X_Th3. If Mean(X1, X2, X3)>X_Th3, then the process may proceed to block 1432, wherein an EPD procedure as described in the present disclosure, e.g., corresponding to FIG. 9, 10, and/or 11 may be performed to determine whether the received bursts correspond to a valid non-NULL page. On the other hand, if at block 1430 it is determined that the mean SNR is not greater than the threshold (e.g., Mean(X1, X2, X3)≦X_Th3), then the process may proceed to block 1410, wherein the MS may schedule the next burst read.

Returning to block 1424, if it is determined that the received n^{th} burst is not the third burst, then the MS may proceed to block 1434 to determine whether the burst is the fourth burst. If the burst is the fourth burst, then the process may proceed to block 1436, wherein the MS may determine whether the SNR X4 observed corresponding to the fourth burst is greater than the SNR threshold utilized for a one-burst case, i.e., X_Th1. If X4>X_Th1, then the process may proceed to block 1438, wherein an EPD procedure as described in the present disclosure, e.g., corresponding to FIG. 9, 10, and/or 11 may be performed to determine whether the n^{th} burst corresponds to a valid non-NULL page. On the other hand, if at block 1436 it is determined that the SNR is not greater than the threshold (e.g., X4≦X_Th1), then the process may proceed to block 1440, wherein the MS may determine whether a mean of the SNR X1 observed corresponding to the first burst, the SNR X2 observed corresponding to the second burst, the SNR X3 observed corresponding to the third burst, and the SNR X4 observed corresponding to the fourth burst, is greater than an SNR threshold used for a three-burst case, i.e., X_Th4. If Mean(X1, X2, X3, X4)>X_Th4, then the process may proceed to block 1442, wherein an EPD procedure as described in the present disclosure, e.g., corresponding to FIG. 9, 10, and/or 11 may be performed to determine whether the received bursts correspond to a valid non-NULL page. On the other hand, if at block 1440 it is determined that the mean SNR is not greater than the threshold (e.g., Mean(X1, X2, X3, X4)≦X_Th4), then the process may proceed to block 1410, wherein the MS may schedule the next burst read.

Of course, this is merely one exemplary algorithm for utilizing different thresholds for an SNR to determine whether to proceed with the EPD algorithm described herein. Variations of the described algorithm, e.g., wherein any suitable combination of multiple bursts as alternatives to the mean calculated in blocks 1420, 1430, and 1440 may be utilized. Furthermore, while FIG. 14 shows exemplary criteria looking at an SNR of observed bursts, in further aspects of the disclosure, the same or similar algorithms may be utilized for one or more other parameters in addition or in alternative to the SNR. For example, referring again to FIG. 11, the same or similar algorithm may be utilized for the paging mode indicator at block 1106. In examples wherein the threshold corresponds to a correlation threshold, such as the page type correlation threshold, and the XMSI correlation threshold, it should be noted that the symbol locations within the burst wherein the relevant bits appear may vary depending upon whether the burst is the first, second, third, fourth, or other burst. Still, the correlations may be combined as described herein above to implement a combined correlation threshold as shown in FIG. 13.

The methods or flowcharts 900, 1000, 1100, and 1400, or one or more portions thereof, may correspond to one or more algorithms that may be used to perform wireless communication. The algorithm(s) may be tied to, or executed by, one or more systems, devices, or components, such as the processor 1204 of FIG. 12 and/or any of the entities shown and described above in connection with FIGS. 1-2. For example, different aspects of the method(s) may be tied to or executed by one or more of the circuits (e.g., circuits 1204a-1204e) and/or one or more items of software (e.g., software 1206a-1206e) as described above.

Several aspects of a telecommunications system have been presented with reference to a GERAN system. As those skilled in the art will readily appreciate, various aspects described throughout this disclosure may be extended to other telecommunication systems, network architectures and communication standards.

By way of example, various aspects may be extended to systems employing UMTS (FDD, TDD), Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication operable at a mobile station (MS), comprising:
receiving one or more bursts of a multi-burst page;
determining a correlation between at least a portion of the one or more bursts and a bit pattern corresponding to a non-NULL page; and
if the correlation is not greater than a threshold, forgoing receiving one or more remaining bursts of the multi-burst page.

2. The method of claim 1, further comprising:
if the correlation is greater than the threshold, receiving one or more of the remaining bursts of the multi-burst page; and
performing early decoding of the page.

3. The method of claim 1, further comprising:
if the correlation is greater than the threshold, receiving one or more of the remaining bursts of the multi-burst page; and
based on a power consumption penalty resulting from performing an early decode operation and/or a performance degradation penalty resulting from omitting the early decode operation, determining to perform the early decode operation of the page.

4. The method of claim 3, further comprising:
determining if an integrity check of the page passes or fails in accordance with the early decode operation; and
if the integrity check fails, scheduling a receiving of a further one or more of the remaining bursts of the multi-burst page.

5. The method of claim 1, further comprising:
determining the bit pattern by encoding bits of a plurality of known page type patterns and mapping encoded bits onto the one or more received bursts; and
determining a page type of the multi-burst page in accordance with a result of the correlation.

6. The method of claim 1, wherein the determining a correlation comprises correlating a plurality of received symbols of the one or more received bursts with a plurality of specific bits corresponding to the bit pattern, the method further comprising:
determining the bit pattern by encoding bits of at least one of an International Mobile Subscriber Identity (IMSI), or a Temporary Mobile Subscriber Identity (TMSI), or a Packet Temporary Mobile Subscriber Identity (P-TMSI) pattern and mapping the encoded bits onto the one or more received bursts.

7. The method of claim 8, wherein the MS comprises a plurality of subscriber identity modules (SIMs), and wherein the encoding bits comprises encoding bits of a plurality of IMSIs, TMSIs, or P-TMSIs corresponding to the plurality of SIMs.

8. The method of claim 1,
wherein the correlation comprises a plurality of correlations each corresponding to one of a plurality of bit patterns including the bit pattern corresponding to a non-NULL page, and
wherein determining a correlation further comprises selecting the highest correlation among the plurality of correlations.

9. The method of claim 1, wherein the one or more bursts comprise a plurality of bursts of the multi-burst page, and wherein the determining a correlation comprises:
determining a correlation for each burst of the plurality of bursts; and
combining correlation results for each of the determined correlations, such that the early decoding of the page is performed if the combined correlation result is greater than the threshold.

10. The method of claim 1,
wherein the receiving one or more bursts comprises receiving a first burst and receiving a second burst, and
wherein the determining a correlation comprises determining a first correlation corresponding to the first burst and determining a second correlation corresponding to the second burst,
the method further comprising determining if the correlation is greater than the threshold by combining the first correlation and the second correlation and comparing the combined correlation to the threshold.

11. The method of claim 1, further comprising:
determining a first signal to noise ratio (SNR) of a first burst of the one or more bursts; and
forgoing the determining a correlation corresponding to the first burst of the multi-burst page if the first SNR is not greater than a SNR threshold.

12. The method of claim 1, further comprising:
comparing a page mode indicator (PMI) value, corresponding to a soft decision value of one or more bits of the one or more received bursts, to a page mode threshold; and
forgoing reading the one or more remaining bursts of the multi-burst page if the PMI value is not greater than the page mode threshold.

13. A mobile station (MS) configured for wireless communication, comprising:
at least one processor;
a computer-readable medium communicatively coupled to the at least one processor; and
a transceiver communicatively coupled to the at least one processor,
wherein the at least one processor is configured to:
receive one or more bursts of a multi-burst page utilizing the transceiver;
determine a correlation between at least a portion of the one or more bursts and a bit pattern corresponding to a non-NULL page; and
if the correlation is not greater than a threshold, forgoing receiving one or more remaining bursts of the multi-burst page.

14. The MS of claim 13, wherein the at least one processor is further configured to:
if the correlation is greater than the threshold, receive one or more of the remaining bursts of the multi-burst page; and
perform early decoding of the page.

15. The MS of claim 13, wherein the at least one processor is further configured to:
if the correlation is greater than the threshold, receive one or more of the remaining bursts of the multi-burst page; and
based on a power consumption penalty resulting from performing an early decode operation and/or a performance degradation penalty resulting from omitting the early decode operation, determine to perform the early decode operation of the page.

16. The MS of claim 15, wherein the at least one processor is further configured to:
determine if an integrity check of the page passes or fails in accordance with the early decode operation; and
if the integrity check fails, schedule a receiving of a further one or more of the remaining bursts of the multi-burst page.

17. The MS of claim 13, wherein the at least one processor is further configured to:
determine the bit pattern by encoding bits of a plurality of known page type patterns and map encoded bits onto the one or more received bursts; and
determine a page type of the multi-burst page in accordance with a result of the correlation.

18. The MS of claim 13, wherein the at least one processor, being configured to determine a correlation, is further configured to correlate a plurality of received symbols of the one or more received bursts with a plurality of specific bits corresponding to the bit pattern, and wherein the at least one processor is further configured to:
determine the bit pattern by encoding bits of at least one of an International Mobile Subscriber Identity (IMSI), or a Temporary Mobile Subscriber Identity (TMSI), or a Packet Temporary Mobile Subscriber Identity (P-TMSI) pattern and map the encoded bits onto the one or more received bursts.

19. The MS of claim 18, further comprising a plurality of subscriber identity modules (SIMs),
and wherein the at least one processor, being configured to encode bits, is further configured to encode bits of a plurality of IMSIs, TMSIs, or P-TMSIs corresponding to the plurality of SIMs.

20. The MS of claim 13,
wherein the at least one processor, being configured to determine a correlation, is further configured to:
determine a plurality of correlations each corresponding to one of a plurality of bit patterns including the bit pattern corresponding to a non-NULL page; and
select the highest correlation among the plurality of correlations.

21. The MS of claim 13, wherein the one or more bursts comprise a plurality of bursts of the multi-burst page, and wherein the at least one processor, being configured to determine a correlation, is further configured to:
determine a correlation for each burst of the plurality of bursts; and
combine correlation results for each of the determined correlations, such that the early decoding of the page is performed if the combined correlation result is greater than the threshold.

22. The MS of claim 13,
wherein the at least one processor, being configured to receive one or more bursts utilizing the transceiver, is further configured to receive a first burst and to receive a second burst, and
wherein the at least one processor, being configured to determine a correlation, is further configured to:
determine a first correlation corresponding to the first burst; and
determine a second correlation corresponding to the second burst, and
wherein the at least one processor is further configured to determine if the correlation is greater than the threshold by combining the first correlation and the second correlation and comparing the combined correlation to the threshold.

23. The MS of claim 13, wherein the at least one processor is further configured to:
determine a first signal to noise ratio (SNR) of a first burst of the one or more bursts; and
forgo determining a correlation corresponding to the first burst of the multi-burst page if the first SNR is not greater than a SNR threshold.

24. The MS of claim 13, wherein the at least one processor is further configured to:
compare a page mode indicator (PMI) value, corresponding to a soft decision value of one or more bits of the one or more received bursts, to a page mode threshold; and
forgo reading the one or more remaining bursts of the multi-burst page if the PMI value is not greater than the page mode threshold.

25. A computer readable medium storing computer executable code,
comprising instructions for causing a mobile station (MS) to:
receive one or more bursts of a multi-burst page;
determine a correlation between at least a portion of the one or more bursts and a bit pattern corresponding to a non-NULL page; and
if the correlation is not greater than a threshold, forgo receiving one or more remaining bursts of the multi-burst page.

26. The computer readable medium of claim 25, wherein the computer executable code further comprises instructions for causing the MS to:
if the correlation is greater than the threshold, receive one or more of the remaining bursts of the multi-burst page; and
perform early decoding of the page.

27. The computer readable medium of claim 25, wherein the computer executable code further comprises instructions for causing the MS to:
if the correlation is greater than the threshold, receive one or more of the remaining bursts of the multi-burst page; and
based on a power consumption penalty resulting from performing an early decode operation and/or a performance degradation penalty resulting from omitting the early decode operation, determine to perform the early decode operation of the page.

28. The computer readable medium of claim 27, wherein the computer executable code further comprises instructions for causing the MS to:
determine if an integrity check of the page passes or fails in accordance with the early decode operation; and
if the integrity check fails, schedule a receiving of a further one or more of the remaining bursts of the multi-burst page.

29. The computer readable medium of claim 25, wherein the computer executable code further comprises instructions for causing the MS to:
determine the bit pattern by encoding bits of a plurality of known page type patterns and mapping encoded bits onto the one or more received bursts; and
determine a page type of the multi-burst page in accordance with a result of the correlation.

30. The computer readable medium of claim 25, wherein the instructions for causing the MS to determine a correlation further comprises instructions for causing the MS to correlate a plurality of received symbols of the one or more received bursts with a plurality of specific bits corresponding to the bit pattern, wherein the computer executable code further comprises instructions for causing the MS to:
determine the bit pattern by encoding bits of at least one of an International Mobile Subscriber Identity (IMSI), or a Temporary Mobile Subscriber Identity (TMSI), or a Packet Temporary Mobile Subscriber Identity (P-TMSI) pattern and map the encoded bits onto the one or more received bursts.

31. The computer readable medium of claim 30, wherein the MS comprises a plurality of subscriber identity modules (SIMs), and wherein the instructions for causing the MS to encode bits comprises instructions for causing the MS to encode bits of a plurality of IMSIs, TMSIs, or P-TMSIs corresponding to the plurality of SIMs.

32. The computer readable medium of claim 25,
wherein the instructions for causing the MS to determine a correlation further comprises instructions for causing the MS to determine a plurality of correlations each corresponding to one of a plurality of bit patterns including the bit pattern corresponding to a non-NULL page, and
wherein the instructions for causing the MS to determine a correlation further comprise instructions for causing the MS to select the highest correlation among the plurality of correlations.

33. The computer readable medium of claim 25, wherein the one or more bursts comprise a plurality of bursts of the multi-burst page, and wherein the instructions for causing the MS to determine a correlation comprises instructions for causing the MS to:
determine a correlation for each burst of the plurality of bursts; and
combine correlation results for each of the determined correlations, such that the early decoding of the page is performed if the combined correlation result is greater than the threshold.

34. The computer readable medium of claim 25,
wherein the instructions for causing the MS to receive one or more bursts comprises instructions for causing the MS to receive a first burst and receiving a second burst, and
wherein the instructions for causing the MS to determine a correlation comprises instructions for causing the MS to determine a first correlation corresponding to the first burst and to determine a second correlation corresponding to the second burst,
the computer executable code further comprising instructions for causing the MS to determine if the correlation is greater than the threshold by combining the first correlation and the second correlation and comparing the combined correlation to the threshold.

35. The computer readable medium of claim 25, wherein the computer executable code further comprises instructions for causing the MS to:
determine a first signal to noise ratio (SNR) of a first burst of the one or more bursts; and
forgo the determining a correlation corresponding to the first burst of the multi-burst page if the first SNR is not greater than a SNR threshold.

36. The computer readable medium of claim 25, wherein the computer executable code further comprises instructions for causing the MS to:
compare a page mode indicator (PMI) value, corresponding to a soft decision value of one or more bits of the one or more received bursts, to a page mode threshold; and
forgo reading the one or more remaining bursts of the multi-burst page if the PMI value is not greater than the page mode threshold.
